(19) United States
(12) Patent Application Publication
(10) Pub. No.: US 2026/0113789 A1
(43) Pub. Date: Apr. 23, 2026

(54) DEDICATED PREAMBLE ALLOCATION FOR RANDOM ACCESS MESSAGES

(71) Applicant: QUALCOMM Incorporated, San Diego, CA (US)

(72) Inventors: Raviteja PATCHAVA, San Diego, CA (US); Jing SUN, San Diego, CA (US); Yan ZHOU, San Diego, CA (US); Junyi LI, Greentown, PA (US); Jing JIANG, San Diego, CA (US)

(21) Appl. No.: 18/924,931

(22) Filed: Oct. 23, 2024

(51) Int. Cl. H04W 74/0833; H04L 1/08; H04W 74/0838

(52) U.S. Cl. CPC H04W 74/0858; H04L 1/08; H04W 74/0838

(57) ABSTRACT

Methods, systems, and devices for wireless communications are described. A user equipment (UE) may use information related to a previously-transmitted random access preamble to determine whether a collision for the preamble exists, and the UE may transmit a subsequent random access message using resources selected in accordance with the determination. For example, the UE may receive a message that indicates path information for respective random access preambles detected by the network node. In some examples, the path information may indicate allocated resources for respective paths corresponding to the detected random access preambles. The UE may determine whether a collision exists for a path corresponding to the previously-transmitted random access preamble. The UE may transmit the subsequent random access message using a first set of resources (e.g., contention-based resources), a second set of resources (e.g., contention-free resources), or an uplink grant, based on whether the collision exists for the path.

### FIELD OF TECHNOLOGY

The present disclosure relates to wireless communications, including dedicated preamble allocation for random access messages.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving, from a network node, a message indicating path information for random access preambles detected by the network node, where the message further indicates, for each path corresponding to the random access preambles, a set of allocated resources including at least a first set of resources, a second set of resources, or an uplink grant, and where the first set of resources corresponds to contention-based random access resources and the second set of resources corresponds to contention-free random access resources, determining, for a path associated with a first random access preamble transmitted by the UE, whether a collision exists for the first random access preamble, where the determination is based on the path information and a round trip time associated with the first random access preamble, and transmitting a random access message including a second random access preamble using the first set of resources, or the second set of resources, or the uplink grant, where the first set of resources, or the second set of resources, or the uplink grant is used for the random access message based on whether the collision exists for the path.

A UE for wireless communications is described. The UE may include one or more memories storing processor executable code, and one or more processors coupled with the one or more memories. The one or more processors may individually or collectively be configured to cause the UE to receive, from a network node, a message indicating path information for random access preambles detected by the network node, where the message further indicates, for each path corresponding to the random access preambles, a set of allocated resources including at least a first set of resources, a second set of resources, or an uplink grant, and where the first set of resources corresponds to contention-based random access resources and the second set of resources corresponds to contention-free random access resources, determine, for a path associated with a first random access preamble transmitted by the UE, whether a collision exists for the first random access preamble, where the determination is based on the path information and a round trip time associated with the first random access preamble, and transmit a random access message including a second random access preamble using the first set of resources, or the second set of resources, or the uplink grant, where the first set of resources, or the second set of resources, or the uplink grant is used for the random access message based on whether the collision exists for the path.

Another UE for wireless communications is described. The UE may include means for receiving, from a network node, a message indicating path information for random access preambles detected by the network node, where the message further indicates, for each path corresponding to the random access preambles, a set of allocated resources including at least a first set of resources, a second set of resources, or an uplink grant, and where the first set of resources corresponds to contention-based random access resources and the second set of resources corresponds to contention-free random access resources, means for determining, for a path associated with a first random access preamble transmitted by the UE, whether a collision exists for the first random access preamble, where the determination is based on the path information and a round trip time associated with the first random access preamble, and means for transmitting a random access message including a second random access preamble using the first set of resources, or the second set of resources, or the uplink grant, where the first set of resources, or the second set of resources, or the uplink grant is used for the random access message based on whether the collision exists for the path.

A non-transitory computer-readable medium storing code for wireless communications is described. The code may include instructions executable by one or more processors to receive, from a network node, a message indicating path information for random access preambles detected by the network node, where the message further indicates, for each path corresponding to the random access preambles, a set of allocated resources including at least a first set of resources, a second set of resources, or an uplink grant, and where the first set of resources corresponds to contention-based random access resources and the second set of resources corresponds to contention-free random access resources, determine, for a path associated with a first random access preamble transmitted by the UE, whether a collision exists for the first random access preamble, where the determination is based on the path information and a round trip time associated with the first random access preamble, and transmit a random access message including a second random access preamble using the first set of resources, or the second set of resources, or the uplink grant, where the first set of resources, or the second set of resources, or the uplink grant is used for the random access message based on whether the collision exists for the path.

In some examples of the method, UEs, and non-transitory computer-readable medium described herein, the path information includes a list of cyclic shifts associated with the random access preambles and the method, apparatuses, and non-transitory computer-readable medium may include further operations, features, means, or instructions for determining that the path associated with the first random access preamble may be indicated by the path information based on the round trip time and a cyclic shift associated with the first random access preamble included in the list of cyclic shifts, where determining whether the collision exists may be based on a quantity of paths associated with the cyclic shift and the round trip time.

In some examples of the method, UEs, and non-transitory computer-readable medium described herein, determining whether the collision exists for the first random access preamble may include operations, features, means, or instructions for determining an absence of the collision for the first random access preamble based on a single path being associated with the cyclic shift and the round trip time, where the random access message may be transmitted using the uplink grant based on the single path being associated with the cyclic shift and the round trip time and in accordance with the message allocating the uplink grant for the single path.

In some examples of the method, UEs, and non-transitory computer-readable medium described herein, determining whether the collision exists for the first random access preamble may include operations, features, means, or instructions for determining an absence of the collision for the first random access preamble based on a single path being associated with the cyclic shift and the round trip time, where the random access message may be transmitted using the second set of resources based on the single path being associated with the cyclic shift and the round trip time and in accordance with the message allocating the second set of resources for the single path.

In some examples of the method, UEs, and non-transitory computer-readable medium described herein, determining whether the collision exists for the first random access preamble may include operations, features, means, or instructions for determining that the collision exists for the first random access preamble based on multiple paths being associated with the cyclic shift and the round trip time, where the random access message may be transmitted using the first set of resources based on the multiple paths being associated with the cyclic shift and the round trip time and in accordance with the message indicating that the first set of resources may be allocated for at least one of the multiple paths.

Some examples of the method, UEs, and non-transitory computer-readable medium described herein may further include operations, features, means, or instructions for retransmitting a first random access message based on the cyclic shift being excluded from the list of cyclic shifts.

In some examples of the method, UEs, and non-transitory computer-readable medium described herein, the cyclic shift may be adjusted by the UE based on a cyclic shift offset and determining whether the collision exists may be based on cyclic shift and the cyclic shift offset.

In some examples of the method, UEs, and non-transitory computer-readable medium described herein, the path information includes a set of cyclic shift windows associated with the random access preambles and the method, apparatuses, and non-transitory computer-readable medium may include further operations, features, means, or instructions for determining that the path associated with the first random access preamble may be indicated by the path information based on the round trip time and based on a cyclic shift associated with the first random access preamble being included in a cyclic shift window of the set of cyclic shift windows, where determining whether the collision exists may be based on the cyclic shift window that includes the cyclic shift.

In some examples of the method, UEs, and non-transitory computer-readable medium described herein, determining whether the collision exists for the first random access preamble may include operations, features, means, or instructions for determining an absence of the collision for the first random access preamble based on the cyclic shift window being associated with an absence of collisions, where the random access message may be transmitted using the uplink grant in accordance with the message allocating the uplink grant for the cyclic shift window.

In some examples of the method, UEs, and non-transitory computer-readable medium described herein, determining whether the collision exists for the first random access preamble may include operations, features, means, or instructions for determining an absence of the collision for the first random access preamble based on the cyclic shift window being associated with an absence of collisions, where the random access message may be transmitted using the second set of resources in accordance with the message allocating the second set of resources for the cyclic shift window.

In some examples of the method, UEs, and non-transitory computer-readable medium described herein, determining whether the collision exists for the first random access preamble may include operations, features, means, or instructions for determining that the collision exists for the first random access preamble based on the cyclic shift window being associated with one or more collisions, where the random access message may be transmitted using the first set of resources in accordance with the message allocating the first set of resources for the cyclic shift window.

Some examples of the method, UEs, and non-transitory computer-readable medium described herein may further include operations, features, means, or instructions for retransmitting a first random access message based on the path information excluding one or more paths associated with the first random access preamble, the round trip time associated with the first random access preamble, or both.

Some examples of the method, UEs, and non-transitory computer-readable medium described herein may further include operations, features, means, or instructions for selecting a transmission power control value for transmitting the random access message based on the path associated with the first random access preamble, where the random access message may be transmitted using the second set of resources.

Some examples of the method, UEs, and non-transitory computer-readable medium described herein may further include operations, features, means, or instructions for computing a timing advance value for transmitting the random access message based on a difference between a cyclic shift indicated by the path information and a first cyclic shift associated with the first random access preamble, the first cyclic shift having a cyclic shift offset applied, where the random access message may be transmitted using the second set of resources.

Some examples of the method, UEs, and non-transitory computer-readable medium described herein may further include operations, features, means, or instructions for applying the timing advance value to the random access message in a time domain, where a cyclic shift corresponding to the second random access preamble corresponds to an allocated cyclic shift of the second set of resources.

Some examples of the method, UEs, and non-transitory computer-readable medium described herein may further include operations, features, means, or instructions for applying the timing advance value to the random access message in a cyclic shift domain, where a cyclic shift corresponding to the second random access preamble may be based on a difference between the timing advance value and an allocated cyclic shift of the second set of resources.

In some examples of the method, UEs, and non-transitory computer-readable medium described herein, the random access message may be transmitted using a first timing advance and a first transmission power control value that respectively correspond to a second timing advance and a second transmission power control value used for transmitting the first random access preamble and the random access message may be transmitted using the first set of resources.

Some examples of the method, UEs, and non-transitory computer-readable medium described herein may further include operations, features, means, or instructions for receiving, from the network node and based on the random access message, a response message including at least a timing advance, a transmission power control value, and one or more resources for an uplink transmission, or any combination thereof, where the random access message may be transmitted using the first set of resources.

Some examples of the method, UEs, and non-transitory computer-readable medium described herein may further include operations, features, means, or instructions for receiving, from the network node and based on the random access message, a response message including one or more resources for an uplink transmission, where the random access message may be transmitted using the second set of resources.

In some examples of the method, UEs, and non-transitory computer-readable medium described herein, the first set of resources may be associated with one or more parameters that may be different from one or more parameters associated with the second set of resources, the one or more parameters including at least a set of candidate cyclic shifts, a set of root sequences, one or more random access occasions, a cyclic shift step size, or any combination thereof.

A method for wireless communications by a network node is described. The method may include obtaining a set of multiple random access preambles from a set of multiple UEs, where each random access preamble of the set of multiple random access preambles is associated with a respective UE, outputting a message indicating path information for the set of multiple random access preambles, where the message further indicates, for each path corresponding to the set of multiple random access preambles, a set of allocated resources including at least a first set of resources, a second set of resources, or an uplink grant, and where the first set of resources corresponds to contention-based random access resources and the second set of resources corresponds to contention-free random access resources, and obtaining, from a UE of the set of multiple UEs, a random access message including a first random access preamble using the first set of resources, or the second set of resources, or the uplink grant, where obtaining the random access message using the first set of resources, or the second set of resources, or the uplink grant is based on whether a collision exists for a path associated with a second random access preamble of the set of multiple random access preambles.

A network node for wireless communications is described. The network node may include one or more memories storing processor executable code, and one or more processors coupled with the one or more memories. The one or more processors may individually or collectively be configured to cause the network node to obtain a set of multiple random access preambles from a set of multiple UEs, where each random access preamble of the set of multiple random access preambles is associated with a respective UE, output a message indicating path information for the set of multiple random access preambles, where the message further indicates, for each path corresponding to the set of multiple random access preambles, a set of allocated resources including at least a first set of resources, a second set of resources, or an uplink grant, and where the first set of resources corresponds to contention-based random access resources and the second set of resources corresponds to contention-free random access resources, and obtain, from a UE of the set of multiple UEs, a random access message including a first random access preamble using the first set of resources, or the second set of resources, or the uplink grant, where obtaining the random access message using the first set of resources, or the second set of resources, or the uplink grant is based on whether a collision exists for a path associated with a second random access preamble of the set of multiple random access preambles.

Another network node for wireless communications is described. The network node may include means for obtaining a set of multiple random access preambles from a set of multiple UEs, where each random access preamble of the set of multiple random access preambles is associated with a respective UE, means for outputting a message indicating path information for the set of multiple random access preambles, where the message further indicates, for each path corresponding to the set of multiple random access preambles, a set of allocated resources including at least a first set of resources, a second set of resources, or an uplink grant, and where the first set of resources corresponds to contention-based random access resources and the second set of resources corresponds to contention-free random access resources, and means for obtaining, from a UE of the set of multiple UEs, a random access message including a first random access preamble using the first set of resources, or the second set of resources, or the uplink grant, where obtaining the random access message using the first set of resources, or the second set of resources, or the uplink grant is based on whether a collision exists for a path associated with a second random access preamble of the set of multiple random access preambles.

A non-transitory computer-readable medium storing code for wireless communications is described. The code may include instructions executable by one or more processors to obtain a set of multiple random access preambles from a set of multiple UEs, where each random access preamble of the set of multiple random access preambles is associated with a respective UE, output a message indicating path information for the set of multiple random access preambles, where the message further indicates, for each path corresponding to the set of multiple random access preambles, a set of allocated resources including at least a first set of resources, a second set of resources, or an uplink grant, and where the first set of resources corresponds to contention-based random access resources and the second set of resources corresponds to contention-free random access resources, and obtain, from a UE of the set of multiple UEs, a random access message including a first random access preamble using the first set of resources, or the second set of resources, or the uplink grant, where obtaining the random access message using the first set of resources, or the second set of resources, or the uplink grant is based on whether a collision exists for a path associated with a second random access preamble of the set of multiple random access preambles.

In some examples of the method, network nodes, and non-transitory computer-readable medium described herein, the path information includes a list of cyclic shifts associated with the set of multiple random access preambles and the method, apparatuses, and non-transitory computer-readable medium may include further operations, features, means, or instructions for selecting, for each path that corresponds to the list of cyclic shifts, the set of allocated resources based on whether the collision may be detected by the network node.

Some examples of the method, network nodes, and non-transitory computer-readable medium described herein may further include operations, features, means, or instructions for detecting a possible collision for the path based on the set of multiple random access preambles including the second random access preamble and allocating the first set of resources or the second set of resources, or both, for the path based at least part on the possible collision, where the random access message may be obtained using the second set of resources or the first set of resources in accordance with the message allocating the first set of resources or the second set of resources, or both, for the path.

Some examples of the method, network nodes, and non-transitory computer-readable medium described herein may further include operations, features, means, or instructions for detecting an absence of the collision for the path based on the set of multiple random access preambles and allocating the uplink grant for the path based at least part on the absence of the collision, where the random access message may be obtained using the uplink grant in accordance with the message allocating the uplink grant for the path, and where the message further includes an indication of a transmission power control value.

In some examples of the method, network nodes, and non-transitory computer-readable medium described herein, the path information includes a set of cyclic shift windows associated with the random access preambles and the method, apparatuses, and non-transitory computer-readable medium may include further operations, features, means, or instructions for selecting, for each cyclic shift window of the set of cyclic shift windows, the set of allocated resources based on whether a collision may be detected by the network node.

In some examples of the method, network nodes, and non-transitory computer-readable medium described herein, a first cyclic shift window of the set of cyclic shift windows may be associated with an absence of the collision, the message allocates the uplink grant for the first cyclic shift window based on the absence of the collision, and the message further indicates a transmission power control value and an indication of a detected cyclic shift corresponding to the first cyclic shift window.

In some examples of the method, network nodes, and non-transitory computer-readable medium described herein, a second cyclic shift window of the set of cyclic shift windows may be associated with a possible collision, the message allocates the first set of resources for the second cyclic shift window based on the possible collision, and the message further indicates a transmission power control value and an indication of one or more detected cyclic shifts corresponding to the second cyclic shift window.

In some examples of the method, network nodes, and non-transitory computer-readable medium described herein, a third cyclic shift window of the set of cyclic shift windows may be associated with a possible collision, the message allocates the second set of resources for the third cyclic shift window based on the possible collision, and the message further indicates a transmission power control value and an indication of a detected cyclic shift corresponding to the third cyclic shift window.

Some examples of the method, network nodes, and non-transitory computer-readable medium described herein may further include operations, features, means, or instructions for determining the set of cyclic shift windows based on respective round trip times corresponding to one or more of the set of multiple random access preambles.

Some examples of the method, network nodes, and non-transitory computer-readable medium described herein may further include operations, features, means, or instructions for outputting, based on the random access message, a response message including at least a timing advance, a transmission power control value, and one or more resources for an uplink transmission, or any combination thereof, where the random access message may be obtained using the first set of resources.

Some examples of the method, network nodes, and non-transitory computer-readable medium described herein may further include operations, features, means, or instructions for outputting, based on the random access message, a response message including one or more resources for an uplink transmission, where the random access message may be obtained using the second set of resources.

In some examples of the method, network nodes, and non-transitory computer-readable medium described herein, the first set of resources may be associated with one or more parameters that may be different from one or more parameters associated with the second set of resources, the one or more parameters including at least a set of candidate cyclic shifts, a set of root sequences, one or more random access occasions, a cyclic shift step size, or any combination thereof.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports dedicated preamble allocation for random access messages in accordance with one or more aspects of the present disclosure.

FIG. 2 shows an example of a wireless communications system that supports dedicated preamble allocation for random access messages in accordance with one or more aspects of the present disclosure.

FIG. 3 shows an example of random access signaling that supports dedicated preamble allocation for random access messages in accordance with one or more aspects of the present disclosure.

FIG. 4 shows an example of a random access process that supports dedicated preamble allocation for random access messages in accordance with one or more aspects of the present disclosure.

FIGS. 5A, 5B, and 5C show an example of a random access process that supports dedicated preamble allocation for random access messages in accordance with one or more aspects of the present disclosure.

FIG. 6 shows an example of a random access process that supports dedicated preamble allocation for random access messages in accordance with one or more aspects of the present disclosure.

FIG. 7 shows an example of a process flow that supports dedicated preamble allocation for random access messages in accordance with one or more aspects of the present disclosure.

FIGS. 8 and 9 show block diagrams of devices that support dedicated preamble allocation for random access messages in accordance with one or more aspects of the present disclosure.

FIG. 10 shows a block diagram of a communications manager that supports dedicated preamble allocation for random access messages in accordance with one or more aspects of the present disclosure.

FIG. 11 shows a diagram of a system including a device that supports dedicated preamble allocation for random access messages in accordance with one or more aspects of the present disclosure.

FIGS. 12 and 13 show block diagrams of devices that support dedicated preamble allocation for random access messages in accordance with one or more aspects of the present disclosure.

FIG. 14 shows a block diagram of a communications manager that supports dedicated preamble allocation for random access messages in accordance with one or more aspects of the present disclosure.

FIG. 15 shows a diagram of a system including a device that supports dedicated preamble allocation for random access messages in accordance with one or more aspects of the present disclosure.

FIGS. 16 through 19 show flowcharts illustrating methods that support dedicated preamble allocation for random access messages in accordance with one or more aspects of the present disclosure.

### DETAILED DESCRIPTION

Some wireless communications systems may utilize random access procedures to enable network access for wireless communications devices (such as user equipment (UEs)). For example, a UE may transmit a message including a random access channel (RACH) preamble (e.g., Msg 1 of a four-step random access procedure) to a network entity via a corresponding random access occasion (RO). The RACH preamble may be randomly selected from a set of predetermined sequences, each of which may be based on a cyclic shift and a root sequence. The RACH preamble may enable the network entity to distinguish between multiple UEs attempting to access the system simultaneously. In response to the RACH preamble, the network entity may transmit a random access response (e.g., Msg 2 of the four-step random access procedure) that provides an uplink resource grant, a timing advance, and an identifier (e.g., a cell-radio network temporary identifier (C-RNTI)) to the UE that transmitted the RACH preamble. The uplink resource grant may be used by the UE for an uplink transmission via a physical uplink shared channel (PUSCH) (e.g., Msg 3 of the four-step random access procedure) after receiving the random access response.

In some cases, however, multiple UEs may select the same RACH preamble, resulting in a collision of not only the preamble transmission, but also with one or more subsequent uplink transmissions by the respective UEs (e.g., collision between respective Msg 3 transmissions by different UEs). As such, additional contention resolution procedures may be implemented to assist UEs in obtaining access to the network. As an example, one or more UEs may apply dithering to a cyclic shift included in a random access message transmission, which may assist the network in identifying distinct paths (e.g., random access paths, paths in a cyclic shift domain) associated with different random access transmissions (and different UEs). Dithering (e.g., cyclic shift dithering) may include an operation in which the UE applies a randomized offset (e.g., a cyclic shift offset) to a selected cyclic shift to mitigate collisions (e.g., when a same RACH preamble is sent at the same time by two or more UEs). Further, in cases where collisions occur, the network entity may transmit one or more additional messages (e.g., Msg X) that provide, to one or more UEs, an indication to select a random access preamble and transmit another random access message (e.g., Msg Y, which may be similar to Msg 1). But, in some cases, the use of one or more additional messages for random access collision resolution may be similarly impacted by multiple UEs transmitting a same RACH preamble at the same time (e.g., via Msg Y). For instance, two or more UEs may again select a same RACH preamble for Msg Y after receiving Msg X. Moreover, such techniques may fail to account for information retained by the UE regarding a previously transmitted RACH preamble, such as information regarding the cyclic shift used by the UE (e.g., the cyclic shift and/or dithering applied), which may enable improved contention resolution decisions.

As described herein, techniques may enable a UE to select different sets of resources based on whether the UE identifies a collision for a random access preamble transmission, where the collision is identified using information the UE has about the random access preamble transmission. As an example, a network entity may provide different sets of resources to a UE for random access procedures, where one set of resources may be selected for transmitting a random access message (e.g., Msg Y) based on a UE's determination of whether a collision for a path (e.g., a random access path) exists. More specifically, when the network entity detects one or more paths (e.g., paths in a cyclic shift domain) having a random access preamble collision, the network entity may transmit a message that indicates a first set of resources associated with contention-based random access, a second set of resources associated with contention-free random access, or an uplink grant. After receiving the message, the UE may determine whether a path associated with a preamble transmitted by the UE is associated with a collision. For example, the UE may receive path information indicated by the message, and the UE may use the path information to determine that, for a cyclic shift and/or path associated with the UE, there is no collision. As such, the UE may transmit a random access message (e.g., Msg Y) using contention-free random access resources. Alternatively, if the UE determines that there is a collision for the cyclic shift and/or path, the UE may transmit the random access message (e.g., Msg Y) using the contention-based random access resources. In some other examples, the network entity may determine that the cyclic shift and/or path is not associated with a collision, and the network entity may indicate, within the path information, that the cyclic shift/path is associated with an uplink grant. In such cases, the UE may use the uplink grant to transmit the random access message (e.g., Msg 3). In any case, the described techniques may enable more efficient random access procedures, particularly in cases of RACH preamble collisions, by using information retained at the UE regarding a previously transmitted cyclic shift. Accordingly, the described techniques may enhance contention resolution for random access procedures by utilizing information at the UE for resolving collisions, which may reduce latency and improve communications efficiency.

Aspects of the disclosure are initially described in the context of wireless communications systems. Some aspects of the disclosure are described with reference to timelines, random access schemes, and process flows. Aspects of the disclosure are further illustrated by and described with reference to apparatus diagrams, system diagrams, and flowcharts that relate to dedicated preamble allocation for random access messages.

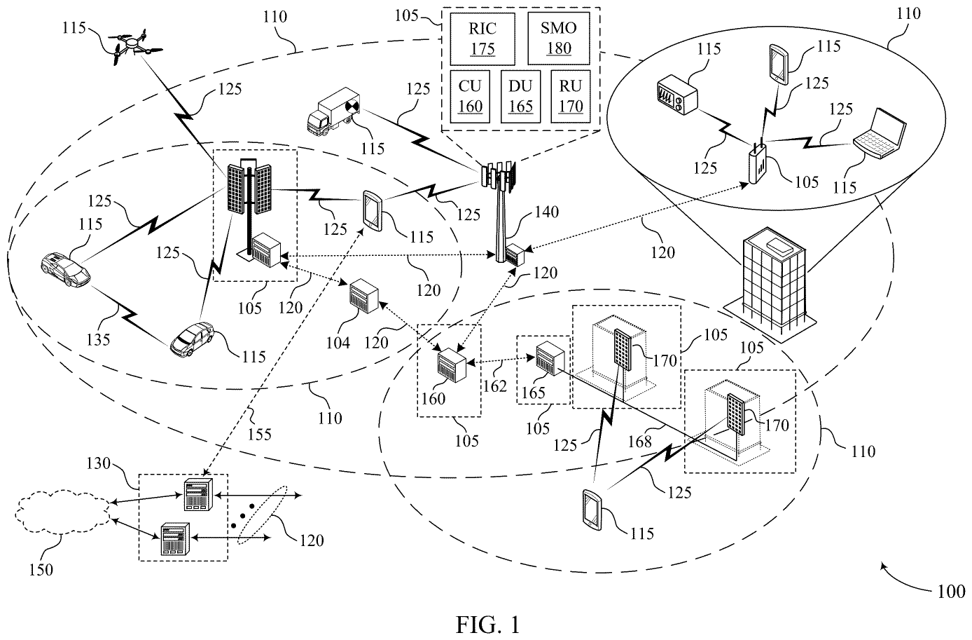

FIG. 1 shows an example of a wireless communications system 100 that supports dedicated preamble allocation for random access messages in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUS 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support dedicated preamble allocation for random access messages as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may utilize random access procedures to enable network access for wireless communications devices (such as UEs 115). For example, after a UE 115 decodes system information, the UE 115 may transmit a RACH preamble to a network entity 105 via an RO as part of a random access procedure (e.g., a two-step random access procedure, a four-step random access procedure). The RACH preamble may be randomly selected from a set of predetermined sequences, which may enable a network entity 105 to distinguish between multiple UEs 115 trying to access the system simultaneously. In one example (such as for four-step random access procedures), the network entity 105 may respond with a random access response that provides an uplink resource grant, a timing advance, and a temporary C-RNTI. The UE 115 may then transmit an RRC connection request along with a TMSI (e.g., if the UE 115 has previously been connected to the same wireless network) or a random identifier. The RRC connection request may also indicate the reason the UE 115 is connecting to the network (e.g., emergency, signaling, data exchange, or the like). The network entity 105 may respond to the connection request with a contention resolution message addressed to the UE 115, which may provide another C-RNTI. If the UE 115 receives a contention resolution message with the correct identification, the UE 115 may proceed with RRC setup. If the UE 115 does not receive a contention resolution message (e.g., if there is a conflict with another UE 115), the UE 115 may repeat the RACH process by transmitting another RACH preamble.

The wireless communications system 100 may support techniques for enabling a UE 115 to use information related to a previously-transmitted random access preamble to determine whether a collision with a RACH preamble exists, and the UE 115 may transmit a subsequent random access message using resources that are based on the determination. For example, the UE 115 may receive a message from the network entity 105 that indicates path information for respective random access preambles detected by the network entity 105. In some examples, the path information may indicate some allocated resources for respective paths corresponding to the detected random access preambles. For instance, the path information may include a list of detected cyclic shifts (e.g., corresponding to respective random access preambles received by the network entity 105 from two or more UEs 115), and the UE 115 may check the list to determine if there are any detected paths that correspond to a cyclic shift and RTT corresponding to a random access preamble transmitted by the UE 115. Additionally, or alternatively, the path information may include an indication of a set of cyclic shift windows (e.g., windows in a cyclic shift domain), and the UE 115 may determine which cyclic shift window of the set of cyclic shift windows corresponds to the cyclic shift associated with a random access preamble transmitted by the UE 115.

Using the path information, the UE 115 may determine whether a collision exists for a path corresponding to the previously-transmitted random access preamble. The UE 115 may transmit the subsequent random access message via a first set of resources (e.g., contention-based resources when a collision is determined), a second set of resources (contention-free resources when no collision is determined), or an uplink grant (e.g., when the network entity 105 identifies that there is no collision with the path of the UE 115), based on whether the collision exists for the path of the UE 115.

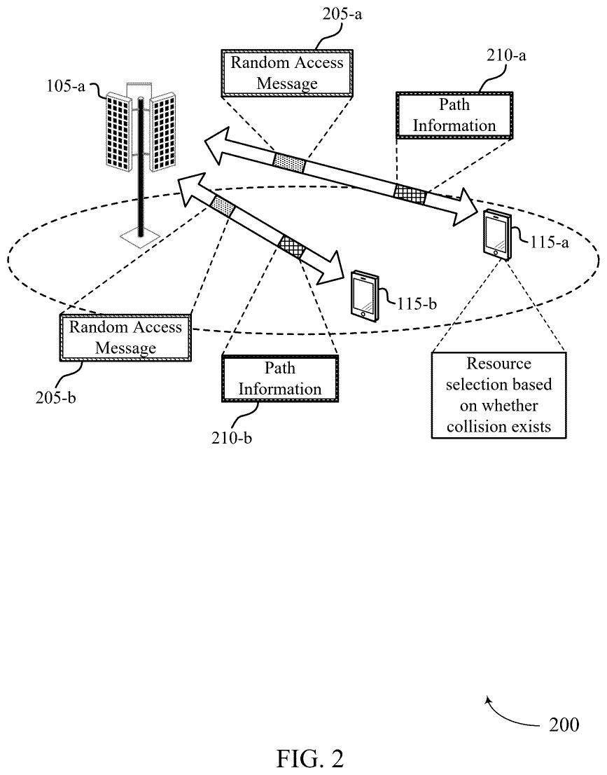

FIG. 2 shows an example of a wireless communications system 200 that supports dedicated preamble allocation for random access messages in accordance with one or more aspects of the present disclosure. The wireless communications system 200 may implement, or be implemented by, aspects of the wireless communications system 100. For example, the wireless communications system 200 may include one or more network entities 105 (e.g., the network entity 105-a, which may be an example of and/or referred to as a network node) and one or more UEs 115 (e.g., a UE 115-a and a UE 115-b), which may be examples of corresponding devices described with reference to FIG. 1. The network entity 105-a may communicate with the UE 115-a and/or the UE 115-b, which may be located within a coverage area associated with the network entity 105-a.

The wireless communications system 200 may support techniques for reducing collisions and improving contention resolution for random access procedures based on information a UE 115 has about a previously transmitted RACH preamble. Such techniques described herein may apply to any random access procedure. For example, some aspects may be described in the context of a four-step random access procedure. However, such techniques may also be applied to any random access procedure (e.g., a two-step random access procedure).

One or more of the UEs 115 in the wireless communications system 200 may perform a random access procedure (e.g., a RACH procedure via a PRACH) to establish or resume a connection (e.g., acquire synchronization with and obtain one or more identifiers for communications with a network). For instance, each UE 115 that is performing a RACH procedure may randomly select a preamble (e.g., a cyclic shift and a root sequence (such as a logical root sequence)), and the UE 115 may transmit a first message in the RACH procedure. As an example, the UE 115-a may select a preamble and a cyclic shift and transmit a first message (e.g., Msg 1) of a four-step RACH procedure via an RO. Likewise, the UE 115-b may select a preamble and a cyclic shift and transmit a first message (e.g., Msg 1) of a four-step RACH procedure via an RO.

The network entity 105-a may detect a respective random access path from each of multiple UEs 115 based on the messages from the UEs 115. Detection of a random access path may correspond to detection of (e.g., reception of and/or processing of) a signal via a channel. For instance, the UE 115-a may select a preamble corresponding to an RO, where each RO may correspond to multiple candidate preambles. Accordingly, the UE 115-a may select a cyclic shift and preamble and transmit Msg 1 via a corresponding RO via a PRACH. The network entity 105-a may monitor for the transmitted preambles (e.g., Msg 1) after each RO. The network entity 105-a may monitor for random access signaling and may detect one or more transmissions (e.g., a first Msg 1 transmitted by the UE 115-a). The network entity 105-a may process (e.g., receive and decode) the Msg 1 and determine the channel based thereon. The detection of the Msg 1 (e.g., the channel detected based on monitoring for and processing the Msg 1) may be referred to as a random access path or a RACH path. For instance, if the network entity 105-a detects (e.g., decodes) the Msg 1 received from the UE 115-a after a given RO (e.g., and prior to a next RO, where a time offset between the RO and the next RO is based on or is equal to a cell size), the network entity 105-a may detect a first random access path (e.g., corresponding to a Msg 1 transmitted by the UE 115-a).

The network entity 105-a may accordingly detect one or more random access paths from multiple UEs 115. For instance, the network entity 105-a may detect a random access path from the UE 115-a (e.g., a Msg 1 transmitted by the UE 115-a) and a random access path from the UE 115-b (e.g., a Msg 1 transmitted by the UE 115-b). The network entity 105-a may transmit a respective response message (e.g., Msg 2) for each of the detected preambles (e.g., a Msg 2 for the UE 115-a and a Msg 2 for the UE 115-b), where each Msg 2 allocates resources for a Msg 3 transmission by the respective UEs 115. After receiving a Msg 2, each UE 115 may transmit a random access message (e.g., Msg 3) and monitor for a contention resolution message (e.g., Msg 4). Similar techniques may be performed for two-step RACH procedures (e.g., the UE 115-a and the UE 115-b may transmit a Msg A and monitor for a Msg B).

If multiple UEs 115 (e.g., the UE 115-a and the UE 115-b) select the same preamble (e.g., and transmit Msg 1 via the same RO), then a collision may occur for the Msg 3 transmission. For example, the UE 115-a and the UE 115-b may both transmit Msg 1 via the same RO, and UE 115-a and UE 115-b may each receive a Msg 2 (e.g., both corresponding to the same selected preamble) granting Msg 3 resources from the network entity 105-a. As the allocated Msg 3 resources are the same for both the UE 115-a and the UE 115-b, both the UE 115-a and the UE 115-b may transmit a Msg 3 using the same resources, resulting in failed transmission by one (e.g., or both) of the UEs 115. For instance, the UE 115-b may transmit a Msg 3 via the same resources as the UE 115-a. The network entity 105-a may not receive the Msg 3 transmitted by the UE 115-b, and the network entity 105-a may therefore not transmit a contention resolution message. The UE 115-b may monitor for a final random access message (e.g., a two or four step RACH procedure), and upon expiration of a timer (e.g., a contention resolution timer), or upon reception of a Msg 4 with a mismatched UE identifier (e.g., a Msg 4 transmitted to the UE 115-a and detected by the UE 115-b), the UE 115-b may reinitiate the RACH procedure (e.g., transmitting another Msg 1 with another preamble and via another RO). Such collisions of random access messages (e.g., Msg 3) may result in increased delays for one or more UEs 115 (e.g., the UE 115-b), increased system congestion and system latency, inefficient use of resources, and the like.

In some examples, the network entity 105-a may perform collision detection using multipath detection (e.g., in the time domain). For example, in some cases (e.g., in case of a relatively large cell), different UEs 115 located in different locations (e.g., near and far) may select a same root sequence and cyclic shift for a RACH transmission. Such transmissions may arrive at the network entity 105-a at different times (e.g., based on a propagation delay), in which case the network entity 105-a may identify (e.g., detect) different UEs 115 based on the arrival time (e.g., difference in time of the same preamble arriving at the network entity 105-a). The network entity 105-a may thus assume a detected multipath for the same cyclic shifts coming from different users and perform collision resolution procedures.

Collision resolution dependent upon multipath detection, however, may result in one or more false positives, such as in the case where a single UE 115 (e.g., UE 115-a) transmits a RACH preamble via multipath signaling (e.g., a MIMO deployment), and the network entity 105-a may interpret such signaling as being a same preamble transmission from multiple UEs 115. Such false positives may result in additional delays and/or increased signaling overhead for collision resolution. Further, in some examples, (e.g., in the case of a relatively small cell where an RTT is similar for multiple UEs 115, or other cases in which the UE 115-a and the UE 115-b are located physically close to one another), an arrival time of RACH preamble signaling (e.g., Msg 1) from multiple UEs 115 may be approximately the same, or may be close enough as to make distinguishing the multiple UEs 115 based on timing difficult or impossible for the network entity 105-a. That is, in some cases, there may be a relatively high probability that the network entity 105-a may only detect a single path when multiple UEs 115 select the same RACH preamble and transmit using the same RO. In such examples, if the UE 115-a and the UE 115-b both transmit the same preamble via the same RO (e.g., and are located close to each other), then the network entity 105-a may fail to successfully detect the multiple UEs 115 based on timing (e.g., the network entity 105-a may detect only a single random access path for both the UE 115-a and the UE 115-b, and may send a single msg 2). Such scenarios may occur in relatively small cells, or in large cells with hot spots and multiple UEs 115 present in a relatively small area, among other examples.

In some cases, to improve multipath detection by the network entity 105-a, one or more UEs 115 may apply a pseudo-random function (e.g., dithering, UE dithering, cyclic shift dithering, cyclic shift offsets) for PRACH transmissions. For example, the UE 115-a and the UE 115-b may select the same preamble for a Msg 1 transmission. However, each UE 115 may apply (e.g., randomly, in accordance with the pseudo-random function) dithering to the cyclic shift (e.g., such that a transmission based on a nominal cyclic shift is modified in accordance with the dithering). Although the network entity 105-a may not have access to information regarding what (e.g., or how much) dithering is chosen (e.g., applied) to a Msg 1 transmission by each UE 115, the network entity 105-a may detect (e.g., identify) distinct cyclic shifts based on the dithering applied by respective UEs 115. Here, the distinct cyclic shifts that are detected may be a result of a UE-selected cyclic shift, the dithering, and a propagation delay translated cyclic shift. In some examples, the dithering may be performed using a selected frequency shift on a transmitted preamble sequence. In accordance with such techniques, multiple UEs 115 may select the same RACH preamble and may have preamble transmissions corresponding to a same RTT (e.g., the UE 115-a and the UE 115-b may be closely located within a coverage area), both the UE 115-a and the UE 115-b may perform the cyclic shift dithering, and the network entity 105-a may detect multiple random access paths. In such cases, the network entity 105-a may perform collision resolution (e.g., procedures to avoid collisions of Msg 3 based on inadvertently granting the same Msg 3 resources to multiple UEs 115) when the multiple paths are detected.

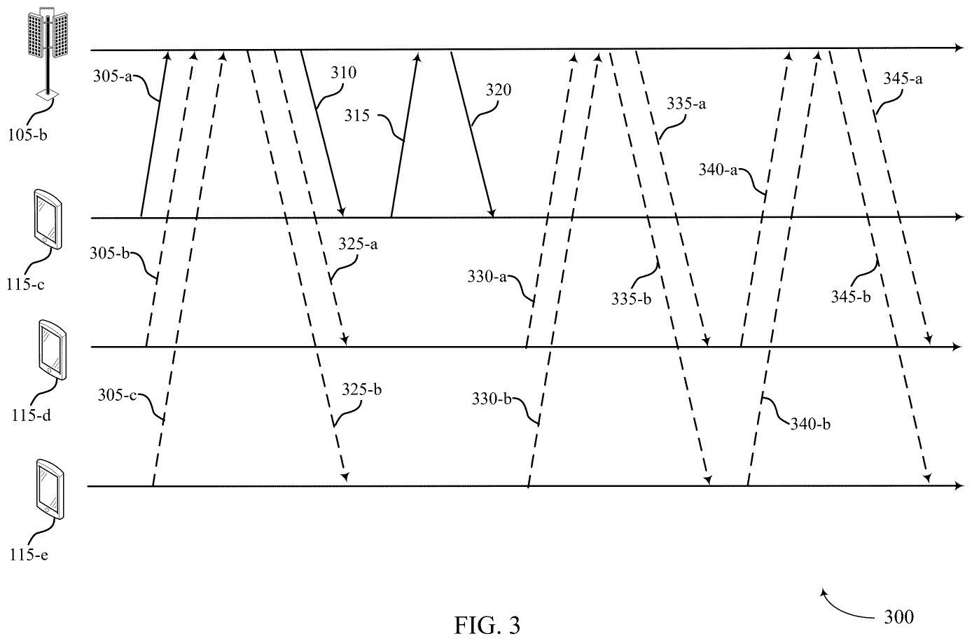

In some examples, there may be scenarios in which the network entity 105-a detects Msg 1 transmissions from multiple UEs 115 (e.g., Msg 1 is transmitted using the same preamble and RO by both the UE 115-a and the UE 115-b), and the network entity 105-a may signal for the UEs 115 to send an additional random access message (e.g., Msg Y) with a new random hashing in a dedicated resource (e.g., RO), such that the respective retransmissions of Msg Y do not collide (e.g., do not have the same root sequence or cyclic shift), resulting in separable random access preamble transmissions, and thereby enabling differentiation of UEs 115 by the network entity 105-a. In particular, the wireless communications system 200 may support one or more additional collision resolution techniques for random access procedures. The network entity 105-a may transmit one or more additional messages (e.g., Msg X) that provide, to one or more UEs 115 (e.g., the UE 115-a and/or UE 115-b), an indication to select a random access preamble and transmit another random access message (e.g., Msg Y, which may be similar to Msg 1). Such techniques are described in further detail with respected to FIG. 3.

In some cases, however, the use of these additional messages for random access collision resolution may be similarly impacted by multiple UEs 115 transmitting a same RACH preamble via a RO (e.g., Msg Y). For instance, after an initial collision of a respective Msg 1 from the UE 115-a and the UE 115-b (which may occur even when dithering is applied), the network entity 105-a may transmit a response message (e.g., Msg X) including an indication to both the UE 115-a and UE 115-b to select (e.g., randomly select) a preamble and transmit a random access message 205 (e.g., Msg Y, which may be similar to Msg 1 and/or Msg A). The UE 115-a and the UE 115-b may transmit the random access message 205 (e.g., Msg Y) including a same RACH preamble, which may result in another collision and/or trigger additional (potentially unnecessary) contention resolution signaling (such as additional Msg X and Msg Y transmissions by one or more UEs 115). Additionally, or alternatively, some UEs may be erroneously categorized as experiencing a collision, which may likewise result in further (potentially unnecessary) collision resolution procedures, resulting in increased delays and system latency. That is, the network entity 105-a may identify a collision based on relatively limited information about the RACH preamble transmissions of multiple UEs (e.g., the network entity 105-a may not have the same information as one or more UEs 115), and the transmission of Msg Y may be prematurely and/or unnecessarily triggered for collision resolution in cases where an actual collision does not exist. Thus, it may be desirable to enhance random access contention resolution procedures to avoid signaling overhead and reduce or minimize the probability of random access collisions for multiple UEs 115.

As described herein, the wireless communications system 200 may support techniques that enable a UE 115 to select different sets of resources based on whether the UE 115 identifies (e.g., detects, determines) a collision for a random access preamble transmission. Here, the collision may be determined using information the UE 115 has about a random access preamble transmission and/or other information retained by the UE 115. As an example, one or more UEs 115 may be capable of detecting random access path collisions, and a UE 115 may use such capabilities to contribute to random access contention resolution. Such techniques may be used to rely on Msg Y for contention resolution only when needed, as a possible collision detected by the network entity 105-a may be resolved by one or more UEs 115, which may avoid contention resolution via Msg Y when a UE 115 determines that a collision between paths (random access paths) does not exist. That is, while some procedures may be used in which the network entity 105-a triggers multiple UEs 115 to re-contend for access using the Msg Y scheme, improved techniques described herein may enable one or more UEs 115 to resolve collisions (e.g., identify an absence of a collision) and avoid re-contenting for access. As a result, fewer UEs 115 may re-contend via Msg Y, which may lead to relatively fewer collisions.

In some aspects, enabling the UE participation in contention resolution may be implemented through the allocation of different sets of resources for the transmission of the random access messages 205 (e.g., Msg Y), where a first set of resources may be configured as contention-based random access (CBRA) resources and a second set of resources may be configured as contention-free random access (CFRA) resources. As an example, when the network entity 105-a detects multiple paths (e.g., multiple random access paths), the CBRA resources or the CFRA resources, or both, may be allocated to any paths where the network entity 105-a determines that a collision is possible, and a UE 115 may select the appropriate set of resources based on whether the UE 115 can resolve a collision between respective paths detected by the network entity 105-a. That is, the network entity 105-a may allocate, for a detected path with a possible collision (e.g., from the perspective of the network entity 105-a), a first set of resources (e.g., CBRA resources) and/or a second set of resources (e.g., a dedicated set of CFRA resources) for the transmission of the random access message 205 (e.g., Msg Y). Further, the network entity 105-a may allocate an uplink grant (e.g., Msg 3 resources) only to the detected paths for which there is no collision detected by the network entity 105-a. A collision for a detected path may be said to exist if there are no other detected paths within a threshold RTT associated with the cell (e.g., one path is within a maximum RTT) for a preamble transmission. Likewise, a collision may be detected when multiple paths are detected within the threshold RTT (e.g., two or more paths are determined to be within the maximum RTT).

Thus, the wireless communications system 200 may support the simultaneous use of contention-based resources and contention-free resources for transmitting the random access message 205. The contention-based resources may be a pool of resources that are shared by each UE 115 that is triggered with a Msg Y transmission, and each UE 115 may select (e.g., randomly select) one or more resources from the pool of resources. As an example, the UE 115-a and the UE 115-b may each receive a Msg X that triggers each UE 115-a to select a preamble and transmit Msg Y (e.g., due to an earlier collision with Msg 1 and/or Msg A). In the event that UE 115-b determines that a collision exists for a preamble transmission associated with the UE 115-b (or, if the UE 115-b is unable to determine or not capable of determining that a collision does not exist), then the UE 115-b may select one or more of the contention-based resources from a pool for the transmission of the random access message 205-b to re-contend via Msg Y.

The contention-free resources may be a set of dedicated resources that are allocated (e.g., assigned) to one or more paths. As an example, the UE 115-a may be capable of determining that a collision does not exist for a path corresponding to a preamble transmission by the UE 115-a, and the UE 115-a may select the contention-free resources for transmitting the random access message 205-a based on the absence of the collision. In some examples, the use of the contention-free resources for the random access message (e.g., Msg Y) transmission may be used to confirm (e.g., indicate) to the network entity 105-a that the detected path associated with the contention-free resources is not associated with a collision, and may further indicate that a random access response (e.g., Msg 3) can be provided to the UE 115-a.

The set of contention-free resources and the set of contention-based resources may differ from each another by at least a set of associated cyclic shifts, one or more root sequences, one or more ROs, or any combination thereof. For example, the contention-free resources may be associated with a first set of cyclic shifts, a first set of root sequences, and/or a first set of ROs. The contention-based resources may be associated with a second set of cyclic shifts, a second set of root sequences, and/or a second set of ROs that are different from the first set of cyclic shifts, the first set of root sequences, and/or the first set of ROs, respectively. In some examples, the set of contention-free resources may have a relatively lower cyclic shift step size compared to the cyclic shift step size for the set of contention-based resources. In some aspects, one or more cyclic shift step sizes for the set of contention-based resource may be similar to a cyclic shift step size used for Msg 1 transmissions.

The network entity 105-a may provide different sets of resources to a UE for random access procedures, where one set of resources may be selected for transmitting a random access message 205 (e.g., Msg Y) based on whether a UE 115 determines an existence of a collision for a path (e.g., a random access path). When the network entity 105-a detects one or more paths (e.g., paths in a cyclic shift domain) having a random access preamble collision, the network entity 105-a may transmit, to one or more UEs 115, a message that includes path information 210. As an example, after detecting possible collisions with a respective Msg 1 transmitted by the UE 115-a and the UE 115-b, the network entity 105-a may transmit path information 210-a to the UE 115-a and transmit path information 210-b to the UE 115-b. In some examples, the message including the path information 210 may further include (e.g., indicate) a first set of resources allocated for the contention-based random access, a second set of resources allocated for the contention-free random access, and/or an uplink grant for a random access message (Msg 3) transmission. In some cases, each set of resources may be associated with one or more path that are detected by the network entity 105-a.

After receiving the message, a UE 115 may determine whether a path associated with a preamble transmitted by the UE 115 is associated with a collision. For example, the UE 115-a may receive the path information 210-a indicated by the message from the network entity 105-a, and the UE 115-a may use the path information 210-a to determine that there is no collision for a cyclic shift and/or path associated with the UE 115-a (e.g., corresponding to a Msg 1 of the UE 115-a). As such, the UE 115-a may transmit a random access message 205-a (e.g., Msg Y) using contention-free random access resources. Alternatively, if the UE 115-a determines that a collision exists for the cyclic shift and/or path associated with its Msg 1 transmission, the UE 115-a may transmit the random access message 205-a (e.g., Msg Y) using the contention-based random access resources. The contention-based random access resources used for transmitting the random access message 205-a may signal, to the network entity 105-a, that a collision was detected by the UE 115-a, which may efficiently enable the use of Msg Y for collision resolution. In such cases, one or more collision resolution procedures associated with the Msg Y transmission using the contention-based resources may only be triggered when necessary, thereby minimizing resource usage and signaling overhead for collision resolution.

In some other examples, the network entity 105-a may detect (e.g., based on cyclic shift dither or other factors) that the cyclic shift and/or path associated with the UE 115-a is not associated with a collision, and the network entity 105-a may indicate, within the message including the path information 210-a, that the cyclic shift/path for the UE 115-a is associated with an uplink grant. In such cases, the UE 115-a may use the uplink grant to transmit the random access message 205-a (e.g., Msg 3 of a four-step random access procedure). The UE 115-b may likewise use the path information 210-b to determine whether collisions exist for one or more preambles and cyclic shifts transmitted by the UE 115-b.

The path information 210 (e.g., the path information 210-a and/or the path information 210-b) may indicate respective paths detected by the network entity, where the paths may correspond to the detected random access preambles from multiple UEs 115. For instance, the path information 210 may include a list of detected cyclic shifts (e.g., corresponding to respective random access preambles received by the network entity 105-a from at least the UE 115-a and the UE 115-b). In such cases, the UE 115-a and/or the UE 115-b may use the list to determine if there are detected paths that correspond to a cyclic shift and RTT corresponding to a random access preamble transmitted by that UE 115.

In some examples, the list of detected cyclic shifts (e.g., indicated by the path information 210) may include a list of detected cyclic shifts for each root sequence (e.g., logical root sequence) of a set of one or more root sequences and provided, from the network entity 105-a to the UEs 115, via a random access message (e.g., Msg 2 and/or Msg X). For example, in a random access message (such as Msg 2 and/or Msg X) for a given root sequence, the list of cyclic shifts may include some cyclic shifts that may be collision-free and some cyclic shifts that may be associated with a potential collision (e.g., from the perspective of the network entity 105-a, based on a quantity of detected paths).

In some cases, the cyclic shifts that are detected by the network entity 105-a as being collision-free may be associated with a resource grant (e.g., Msg 3 resources for a Msg 3 transmission may be allocated by the network entity 105-a for the collision-free cyclic shifts). In some aspects, the cyclic shift(s) that are detected by the network entity 105-a as having a potential collision may be associated with a set of contention-based resources (e.g., CBRA resources for a Msg Y transmission may be allocated by the network entity 105-a for the cyclic shifts associated with a potential collision). Here, a same set of contention-based resources (e.g., CBRA resources) may be provided for one or multiple detected cyclic shifts. Further, the indication of the set of contention-based resources may further include a transmit power control (TPC) command to be used for uplink transmission power control by a UE 115 transmitting the Msg Y via the contention-based resources. The cyclic shifts that are detected by the network entity 105-a and indicated as having a potential collision may additionally, or alternatively, be associated with a set of contention-free resources (e.g., CFRA resources for a Msg Y transmission may be optionally allocated by the network entity 105-a for the cyclic shifts associated with a potential collision). The allocation of the contention-free resources may be provided (e.g., allocated) by the network entity 105-a if there is chance that the UE 115 transmitting a preamble and cyclic shift included in those having a potential conflict can determine whether the cyclic shift is associated with a collision.

Additionally, or alternatively, the path information 210 may include an indication of a set of cyclic shift windows (e.g., windows in a cyclic shift domain), and the UE 115-a and/or UE 115-b may determine which cyclic shift window of the set of cyclic shift windows corresponds to a cyclic shift associated with a random access preamble transmitted by that UE 115. In such cases, the UE 115 may select the set of resources based on which cyclic shift window corresponds to its own cyclic shift transmission (e.g., via Msg 1).

In some examples, the multiple cyclic shift windows (e.g., indicated by the message carrying the path information 210) may be a set of cyclic shift windows for each root sequence (e.g., logical root sequence) of a set of one or more root sequences, which may be provided, from the network entity 105-a to the UEs 115, via a random access message (e.g., Msg 2 and/or Msg X). For example, in a random access message (such as Msg 2 and/or Msg X) for a given root sequence, multiple cyclic shift windows may be indicated via the path information 210. For each cyclic shift window, the network entity 105-a may indicate an uplink grant, the set of contention-based resources, or the set of contention-free resources, which may be used by a UE 115 for transmitting the random access message 205.

As an example, one or more first cyclic shift windows may be allocated with an uplink grant (e.g., including Msg 3 resources for a Msg 3 transmission), and the message indicating the one or more first cyclic shift windows may further indicate an associated TPC value and detected cyclic shift(s) for the one or more first cyclic shift windows. Additionally, or alternatively, one or more second cyclic shift windows may be allocated with the set of contention-based resources (e.g., the CBRA resources) for a Msg Y transmission, which may correspond to a single RO or multiple ROs. A list of detected cyclic shifts associated with the one or more second cyclic shift windows may be indicated for the one or more second cyclic shift windows. In some cases, a same set of contention-based resources may be provided for (e.g., allocated to) multiple cyclic shift windows. In some aspects, one or more third cyclic shift windows may be associated with the contention-free resources for the Msg Y transmission. In some examples, a TPC command and/or one or more detected cyclic shifts associated with the one or more third cyclic shift windows may be indicated along with the one or more third cyclic shift windows. In any event, a UE 115 may determine which window its own cyclic shift is associated with and select the corresponding resources for the transmission of the random access message 205.

As an example, the UE 115-a may use the path information 210-a to determine that a preamble and cyclic shift the UE 115-a transmitted is associated with the one or more third cyclic shift windows (e.g., the UE 115-a may determine that its own cyclic shift is not associated with a collision, based on the cyclic shift window associated with its cyclic shift), and the UE 115-a may accordingly transmit the random access message 205-a using the contention-free resources (e.g., the CFRA resources). In another example, the UE 115-a may determine that a preamble and cyclic shift the UE 115-a transmitted is associated with the one or more second cyclic shift windows (e.g., the UE 115-a may determine that collision exists for its own cyclic shift), and the UE 115-a may transmit the random access message 205-a using the contention-based resources (e.g., the CBRA resources). The UE 115-b may similarly use the path information 210-b to determine which cyclic shift window is associated with its own cyclic shift transmission.

After receiving the random access message 205 (e.g., Msg Y), the network entity may decode the random access message and transmit a response (e.g., Msg Y2) based on the resources used for receiving the random access message. As an example, when the random access message 205-b from the UE 115-b is received via the set of contention-based resources, the response from the network entity 105-a (e.g., Msg Y2, a random access response) may include an indication of a timing advance (TA), a TPC command, and/or an uplink grant (e.g., Msg 3 resources for a Msg 3 transmission). In other cases, the response (e.g., Msg Y2, the random access response) may include an indication of the uplink grant (e.g., Msg 3 resources for a Msg 3 transmission) and optionally a TA and/or TPC command. Here, the TA and/or TPC command may be optional for a response to a random access message 205 received via the set of contention-free resources because the TA and TPC command may have been previously indicated (e.g., via an earlier Msg 2 transmission).

The techniques described herein may enable more efficient random access procedures, particularly in cases of RACH preamble collisions, by using information retained at the UE 115 regarding a previously transmitted cyclic shift. Accordingly, the described techniques may enhance contention resolution for random access procedures by relying on a capability of a UE 115 for identifying collisions, which may reduce latency and improve communications efficiency.

FIG. 3 shows an example of random access signaling 300 that supports dedicated preamble allocation for random access messages in accordance with one or more aspects of the present disclosure. The random access signaling 300 may implement, or be implemented by, aspects of the wireless communications system 100 and the wireless communications system 200. For example, one or more network entities 105 (e.g., a network entity 105-b) and one or more UEs 115 (e.g., a UE 115-c, a UE 115-d, and a UE 115-c), which may be examples of corresponding devices described with reference to FIGS. 1 and 2, may communicate for random access contention resolution in accordance with the random access signaling 300. Although illustrated with reference to a four-step random access procedure, techniques described herein may be similarly applied to any random access procedure (e.g., a two-step random access procedure).

In some examples, the network entity 105-b may perform collision detection (e.g., based on dithering performed by one or more UEs 115). For example, the UE 115-c, the UE 115-d, and the UE 115-e may each transmit a random access message 305 (e.g., Msg 1) via a same RO. Two or more of the UEs 115 may select a same preamble, but may apply dithering (e.g., cyclic shift dithering) to the selected cyclic shift. The network entity 105-b may detect multipath scenarios based on the difference between multiple paths, and may trigger either a random access response 310 (e.g., Msg 2 granting Msg 3 resources, a random access message), or a random access response 325 (e.g., a random access message). The network entity 105-b may detect multiple random access paths (e.g., a preamble with preamble collision), but may not assign an accurate timing to the detected UEs 115 (e.g., the network entity 105-b may be unable to distinguish between the preamble transmitted by UE 115-d and UE 115-c), resulting in a possible detected collision. The network entity 105-b may thus transmit a random access response 325 to colliding UEs 115, and a random access response 310 to non-colliding users. Preamble collision detection by the network entity 105-b may be based on various implementations, and may depend on a cyclic shift difference between detected paths.

For example, the UE 115-c may transmit the random access message 305-a (e.g., Msg 1), the UE 115-c may transmit the random access message 305-b (e.g., Msg 1), and the UE 115-e may transmit the random access message 305-c (e.g., Msg 1). In some examples, the random access message 305-b and the random access message 305-c may correspond to a same RACH preamble (e.g., whereas the random access message 305-a may correspond to a different preamble). In some examples, the random access message 305-a may correspond to the same preamble of the random access message 305-b and the random access message 305-c, but a cyclic shift dither applied by the UE 115-c may enable the network entity 105-b to effectively distinguish between the random access message 305-a and other detected random access paths. As such, the network entity 105-b may detect a random access path corresponding to the UE 115-c, and the network entity 105-b may detect one or more additional random access paths corresponding to the UE 115-d and the UE 115-e (e.g., the network entity 105-b may detect a collision between Msg 1 transmissions by the UE 115-d and the UE 115-e). The network entity 105-b may transmit the random access response 310 (e.g., Msg 2, a random access message) to the UE 115-c (e.g., based on an absence of a detected collision), and the random access response 310 may grant resources for the random access message 315 (e.g., Msg 3). The UE 115-c may transmit the random access message 315, and receive a contention resolution message 320.

The network entity 105-b may transmit a random access response 325 to colliding users. For example, the network entity 105-b may determine (e.g., based on the detected random access paths corresponding to the UE 115-d and the UE 115-e) a potential collision between the UE 115-d and the UE 115-e. A random access response 325 may be referred to, for example, as Msg X, or message X, or Msg 2, among other examples. For example, the random access response 325 may be similar to or the same as a Msg 2 in a four-step random access procedure, and the random access response 325 may allocate resources for another random access message (e.g., a random access message 330, which may be referred to as Msg Y, message Y, or Msg 3, among other examples). For instance, a random access response 310 (e.g., Msg 2) may grant resources for a continuation of an initiated random access procedure (e.g., Msg 2 grants resources for Msg 3). A random access response 325 (e.g., Msg X) may grant resources for initiating or continuation an additional random access procedure (e.g., Msg X may grant resources for transmitting another random access message such as Msg 1). In some examples, the random access response 325 may include an indication to select (e.g., randomly select) a RACH preamble for transmission in the random access message 330 (e.g., Msg Y).

If a UE 115 receives a random access response 325 (e.g., Msg X), the UE 115 may therefore randomly select a preamble and transmit a random access message 330 (e.g., for contention resolution). In some examples, a random access message 330 (e.g., random access message 330-a, random access message 330-b) may be the same as or similar to a Msg 1 or a Msg A. For example, the UE 115-d may select a preamble (e.g., corresponding to the resources indicated by the Msg X) and may transmit a random access message 330-a, which may be similar to Msg 1 (e.g., may correspond to a selected preamble, cyclic shift, root sequence, or the like). In some examples, a random access message 330 may be referred to as a Msg Y. Additionally, or alternatively, the UE 115-e may receive the random access response 325-b (e.g., Msg X) and transmit, in response, the random access message 330-b (e.g., Msg Y) including a RACH preamble.

In some cases, the transmission of a random access message 330 may be followed by one or more additional exchanges of messages between the network entity 105-b and one or more UEs 115 (e.g., UE 115-d, UE 115-e). As an example, after receiving the random access message 330, an additional random access message 335 (e.g., similar to a Msg 2 or Msg B), which may be referred to as a Msg Y2, may be transmitted to the UE 115-d, the UE 115-e, or both by the network entity 105-b. In the case of a four-step random access procedure, a random access message 340 (e.g., a random access message 340-a, a random access message 340-b) may be referred to as a Msg Y3, and a random access message 345 (e.g., a contention resolution message, random access message 345-a, random access message 345-b) may referred to as a Msg Y4.

The devices in a network may therefore perform contention resolution procedures, including transmission of a random access response 310 to a UE 115-c (e.g., for which no collision is detected) and transmission of a random access response 325 to UEs 115 for which contention is detected. The network entity 105-b may transmit the random access response 325-a (e.g., a Msg X) to the UE 115-d (e.g., granting a first set of resources for a random access message 330-a), and may transmit a random access response 325-b (e.g., a Msg X) to the UE 115-c (e.g., granting the same set of resources, or different resources, for a random access message 330-b). The UE 115-d may select a preamble and may transmit the random access message 330-a (e.g., Msg Y) as indicated by the random access response 325-a, and the UE 115-e may select a preamble and transmit the random access message 330-b (e.g., Msg Y) as indicated by the random access response 325-b. The network entity 105-b may transmit the random access message 335-a (e.g., Msg Y2) to the UE 115-d and may transmit the random access message 335-b (e.g., Msg Y2) to the UE 115-c. The UE 115-d may transmit the random access message 340-a via resources indicated by the random access message 335-a, and the UE 115-e may transmit the random access message 340-b via resources indicated by the random access message 335-b. The network entity 105-b may transmit the random access message 340-a to the UE 115-d, and the network entity 105-b may transmit the random access message 340-b to the UE 115-c.

In some examples, detected paths may occur within a threshold duration (e.g., a cyclic shift step size, an RTT threshold, a max RTT duration of the cell) of each other, and the network entity 105-b may not be able to effectively determine whether a collision has occurred. The threshold duration may be defined by or based on a threshold (e.g., maximum) RTT within the cell. In some examples, the threshold duration may be greater than the RTT for a preamble transmission. For example, the threshold duration may be selected such that it covers the threshold (e.g., maximum) RTT of a cell. In some examples, a first cyclic shift offset may be selected to be relatively smaller than the threshold duration (e.g., the UE 115 may not have access to information indication the RTT for the UE, and may randomly select the cyclic shift offset to be smaller than the threshold RTT). The network entity 105-b may determine that, because the detected paths occur within the threshold duration of each other, there is a collision (e.g., because the network entity 105-b does not have access to a translated time (cyclic shift offset and propagation time) of each random access message according to a cyclic shift dither).

In some cases, one or more UEs 115 may be able to effectively determine accurate timing for transmitted RACH preambles. For example, the network entity 105-b may detect two paths corresponding to UE 115-d and UE 115-e, with a delay difference that is less than a threshold duration. The UE 115-d, however, may detect a single path (e.g., its own path) within the threshold duration from its transmission of the preamble (e.g., via Msg 1, the random access message 305-b), and the UE 115-d may accurately detect the timing. Additionally, the UE 115-e may detect two paths (e.g., the path corresponding to the UE 115-d and its own path) within the threshold duration from its transmission of the preamble and may benefit from (e.g., rely on) a transmission of a Msg Y for accurate timing detection.

As described herein, the network entity 105-b may transmit a response message to each UE 115 (e.g., Msg X) for collision resolution, where each message allocates multiple resource sets for each UE 115 (e.g., resources for both a Msg 3 and/or a Msg Y), and a UE 115 may determine which set of resources to use for transmitting the random access message 330 based on whether a collision is detected by the UE 115. More specifically, a UE 115 may use information related to a previously-transmitted random access preamble (e.g., Msg 1, a random access message 305) to determine whether a collision with the random access preamble exists, and the UE 115 may transmit the subsequent random access message 330 using resources that are based on the determination. For example, the UE 115 may receive the random access response 325 from the network entity 105 indicating path information for respective random access preambles detected by the network entity 105 (e.g., the random access messages 305-a, 305-b, and 305-c). In some examples, the message including the path information may further indicate some allocated resources for respective paths corresponding to the detected random access preambles. For instance, the path information may include a list of detected cyclic shifts (e.g., corresponding to respective random access preambles received by the network entity 105 from the UE 115-c, the UE 115-d, and the UE 115-c), and a UE 115 may check the list to determine if there are any detected paths that correspond to a cyclic shift and RTT corresponding to a random access preamble transmitted by the UE 115. In one example, the list of detected cyclic shifts may indicate that a cyclic shift associated with the random access message 305-a is associated with resources for an uplink grant, and the list may further indicate that both a first cyclic shift (e.g., associated with the random access message 305-b) and a second cyclic shift (e.g., associated with the random access message 305-c) is associated with two different sets of resources. Here, the two different sets of resources may include a first set of resources (e.g., contention-based resources, which may be referred to as CBRA resources or some similar terminology) and a second set of resources (e.g., contention-free resources, which may be referred to as CFRA resources or some similar terminology).

The UE 115 receiving the path information included in the random access response 325 may select from the first set of resources or the second set of resources based on whether that UE 115 detects a collision (e.g., based on information that particular UE 115 possesses regarding its own Msg 1 transmission). As an illustrative example, the UE 115-d may receive the random access response 325-a including the path information. The UE 115-d may determine that a path associated with the random access message 305-b (its own preamble transmission), which may be based on a RTT associated with the random access message 305-b, is allocated both the first set of resources (contention-based resources) and the second set of resources (contention-free resources) using the path information. The UE 115-d may further determine that a collision does not exist for the path, and the UE 115-d may accordingly use the second set of resources (e.g., the contention-free resources) for transmitting the random access message 330-a. Alternatively, the UE 115-d may determine that the collision exists (e.g., the UE 115-d may detect two paths (such as the path corresponding to the UE 115-e and its own path) within the threshold duration from its transmission of the preamble), and the UE 115-d may transmit the random access message 330-a (Msg Y) using the first set of resources (e.g., the contention-based resources).

In some examples, the path information may include an indication of a set of cyclic shift windows (e.g., windows in a cyclic shift domain), and a UE 115 may determine which cyclic shift window of the set of cyclic shift windows corresponds to the cyclic shift associated with a random access preamble transmitted by the UE 115. In such cases, different cyclic shift windows of the set of cyclic shift windows may be associated with respective resource allocations. For instance, a first cyclic shift window of the set of cyclic shift windows may be allocated with the first set of resources (e.g., contention-based resources), a second cyclic shift window may be allocated with the second set of resources (e.g., contention-free resources), and a third cyclic shift window may be allocated with an uplink grant (e.g., for transmitting Msg 3, the random access message 315). Accordingly, a UE 115 receiving the path information including the set of cyclic shift windows may determine, based on information regarding the UE's own Msg 1 transmission, which cyclic shift window corresponds to the Msg 1 transmitted by the UE 115. The UE 115 may then use the allocated resources (the first set of resources, the second set of resources, or the uplink grant) for transmitting the random access message 330 (e.g., Msg Y).

Using the path information, a UE 115 may determine whether a collision exists for a path corresponding to a previously-transmitted random access preamble. The UE 115 may transmit the subsequent random access message (e.g., the random access message 330) via a first set of resources (e.g., contention-based resources when a collision is determined), a second set of resources (contention-free resources when no collision is determined), or an uplink grant (e.g., when the network entity 105 identifies that there is no collision with the path of the UE 115), based on the UE's determination of whether the collision exists for the path of the UE 115.

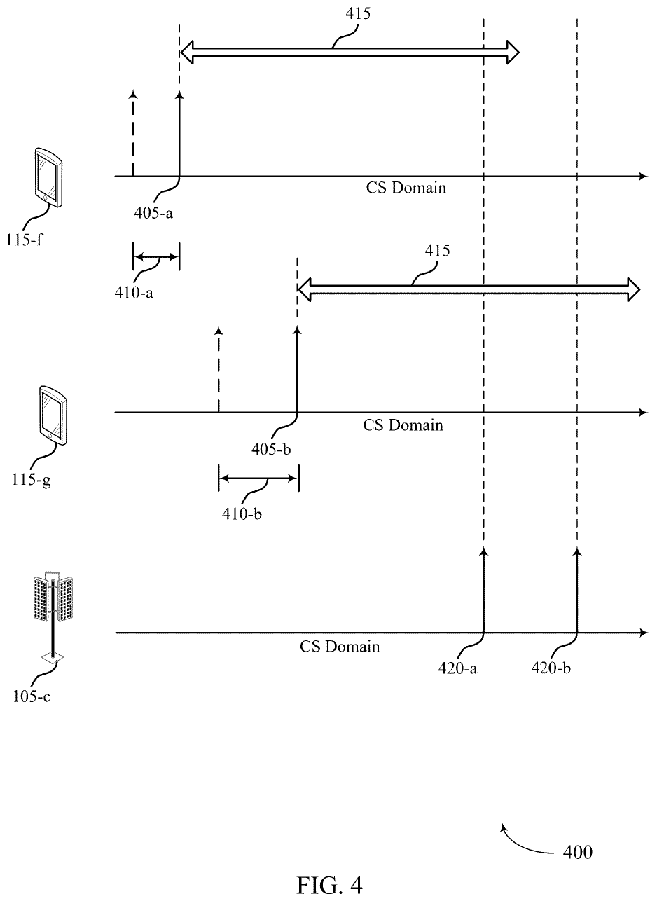

FIG. 4 shows an example of a random access process 400 that supports dedicated preamble allocation for random access messages in accordance with one or more aspects of the present disclosure. The random access process 400 may implement, or be implemented by, aspects of the wireless communications system 100, the wireless communications system 200, and the random access signaling 300. For example, one or more network entities 105 (e.g., a network entity 105-c, which may be an example of a network node) and one or more UEs 115 (e.g., a UE 115-f, a UE 115-g), which may each be examples of corresponding devices described with reference to FIGS. 1-3, may communicate according to the random access process 400. As an example, the UEs 115 and the network entity 105-c may exchange signaling for one or more random access procedures. Although described with reference to a four-step random access procedure, techniques described herein may be similarly applied to any random access procedure (e.g., a two-step random access procedure).

Each UE 115 may randomly select a preamble (e.g., a RACH preamble), and may apply a random dithering for transmitting a cyclic shift 405 via a random access message (e.g., Msg 1). For example, the UE 115-f may select a preamble and a cyclic shift 405-a, where cyclic shift dithering 410-a may have cyclic shift 405-a applied, for a transmission of a random access message. The UE 115-g may similarly select a preamble and a cyclic shift 405-b, which may have cyclic shift dithering 410-b applied, for a random access message. In some examples, the UE 115-f and the UE 115-g may select a same preamble and cyclic shift, which has the potential to result in a collision.

The network entity 105-c may detect multiple paths 420 (e.g., random access paths) corresponding to Msg 1 signals. For example, the network entity 105-c may detect the random access path 420-a and the random access path 420-b, each of which may correspond to a random access preamble transmission a respective UE 115. For example, each path 420 may correspond to a respective cyclic shift 405 transmitted via a random access message. In some examples, the network entity 105-c may determine a potential collision between two or more random access paths 420. For instance, the network entity 105-c may determine that the random access path 420-a and the random access path 420-b are detected within an offset that is less than a threshold duration 415 (e.g., which may be based on or may be equivalent to a RTT for the cell associated with the network entity 105-c, a cyclic shift step size). In such cases, the network entity 105-c may be unable to determine which path 420 belongs to which cyclic shift 405 (and, correspondingly, to which UE 115).

One or more other paths 420 detected by the network entity 105-c may not be associated with a potential collision. For example, the network entity 105-c may determine that there is no collision for a random access path 420 (which may be associated with another UE 115), as the network entity 105-c may detect that no other multiple random access paths 420 are located within the threshold duration 415 of the random access path 420 (e.g., the network entity 105-c may determine that only one possible UE 115 sent the corresponding random access preamble transmission). However, the network entity 105-c may be uncertain as to whether a collision occurs between the random access path 420-a and the random access path 420-b (e.g., the network entity 105-c may be unable to accurately determine a timing difference at the corresponding UEs 115).

Thus, even when cyclic shift dithering is used by the UEs 115, there may be scenarios where respective paths 420 detected by the network entity 105-c are within one cyclic shift step size duration, and the paths 420 may not be distinguishable from one another. Here, a cyclic shift step size duration may be decided based on a threshold RTT (e.g., maximum RTT) within the cell. Some UEs 115, however, may be capable of and/or support techniques for identifying the accurate timing of their own cyclic shift 405. Put another way, while the network entity 105-c may be unable to accurately estimate preamble collisions based on the detected paths 420-a and 420-b, one or more UEs 115 (e.g., UE 115-f, UE 115-g) may have information available to resolve any potential collision. The UEs 115 may have more information (e.g., information regarding a cyclic shift transmitted by that UE 115) than the network entity 105-c, so the UE 115 may assist in identifying which detected path 420 corresponds to the UE's own random access message transmission.

As an example, the network entity 105-c detects the paths 420-a and 420-b, but is unable to determine which cyclic shift 405 (and which UE 115) each path 420 is associated with. For the UE 115-f, however, only the path 420-a detected by the network entity 105-c is within a threshold duration 415 (e.g., threshold RTT) from the transmission of the cyclic shift 405-a. The UE 115-f may accordingly be able to identify, based on information associated with the cyclic shift 405-a (e.g., Msg 1), that there is no collision between the two paths 420. That is, the network entity 105-c may detect a possible collision, but the UE 115-f may have information enabling the UE 115-f to determine that no collision exists. Accordingly, the UE 115-f may not need to contend for access using Msg Y, as no actual collision exists.

In other examples, both paths 420-a and 420-b may be within the threshold duration (e.g., threshold RTT) of the cyclic shift 405-b transmitted by the UE 115-g. As a result, the UE 115-g may benefit from additional signaling (e.g., Msg X, Msg Y) exchanged with the network entity 105-c for accurate timing detection and collision resolution. But conventional techniques for random access collision resolution may omit or fail to account for the information a UE 115 has about its own cyclic shift 405. As an example, when potential collisions between multiple paths 420 are detected by the network entity 105-c, the network entity 105-c may conventionally transmit a random access message (e.g., Msg X) to multiple UEs 115, which may lead to a relatively increased probability of further collisions for Msg Y, even though one or more UEs 115 (such as UE 115-f in the above example) may be capable of resolving at least some collisions associated with the paths 420. Accordingly, by utilizing information retained at a UE 115 about its own preamble transmission, additional signaling and avoidable delays may be avoided for collision resolution.

Thus, as described herein, if a UE 115 is capable of resolving a collision, the UE 115 may not need to contend for access again, thereby avoiding collisions with Msg Y transmissions and increasing efficiency. In particular, techniques may be implemented to enable a UE 115 to use information related to a previously-transmitted cyclic shift 405 to determine whether a collision with a RACH preamble exists, and the UE 115 may transmit a subsequent random access message (e.g., Msg Y) using resources that are based on the determination. For example, the UE 115 may receive a message from the network entity 105-c that indicates path information for respective random access preambles detected by the network entity 105 (e.g., the path information may indicate at least paths 420-a and 420-b).

In some examples, the path information may indicate some allocated resources for the respective paths 420. For instance, the path information may indicate some detected cyclic shifts (e.g., corresponding to the paths 420), and the UE 115 may use the path information to determine if there are any detected paths 420 that correspond to a cyclic shift and RTT corresponding to a cyclic shift 405 transmitted by the UE 115. As an example, the UE 115-f may receive the path information indicating multiple paths including at least the paths 420-a and 420-b, and the UE 115-f may determine that the path 420-a is within a threshold RTT of a cyclic shift corresponding to the cyclic shift 405-a (after cyclic shift dithering), which was transmitted by the UE 115-f. The UE 115-f may therefore be capable of determining that no conflict exists between the path 420-a and the path 420-b (e.g., because the UE 115-f may determine that path 420-a corresponds to its own preamble transmission). Using this information, the UE 115-f may select resources allocated to the path 420-a that are associated with an absence of a collision, where the resource allocation may be indicated by the message carrying the path information (or using another message or configuration). For example, the UE 115-f may select a set of resources that are configured as CFRA resources for the transmission of a random access message (e.g., Msg Y), where such resource selection may indicate to the network entity 105-c (e.g., based on receiving the Msg Y via the CFRA resources) that the path 420-a is associated with the UE 115-f, thereby avoiding additional signaling for collision resolution.

The UE 115-g may receive the path information, and the UE 115-g may determine that it is unable to resolve the collision between the path 420-a and the path 420-b (e.g., because both paths 420 are within a threshold RTT of a cyclic shift associated with the cyclic shift 405-b transmitted by the UE 115-g). In such cases, the UE 115-g may select a set of resources that are configured as CBRA resources for the transmission of a random access message (e.g., Msg Y). The use of the CBRA resources when transmitting Msg Y may indicate, to the network entity 105-c (e.g., based on receiving the Msg Y via the CBRA resources), that a collision between paths 420 is unable to be resolved by the UE 115-g, which may trigger additional processes and/or signaling for contention resolution for the UE 115-g. Thus, the path information provided to the UEs 115 may enable respective UEs 115 to determine whether perceived collisions detected by the network entity 105-c are actual collisions or not, which may provide for enhanced random access procedures, reduce latency, and avoid or limit excess resource use.

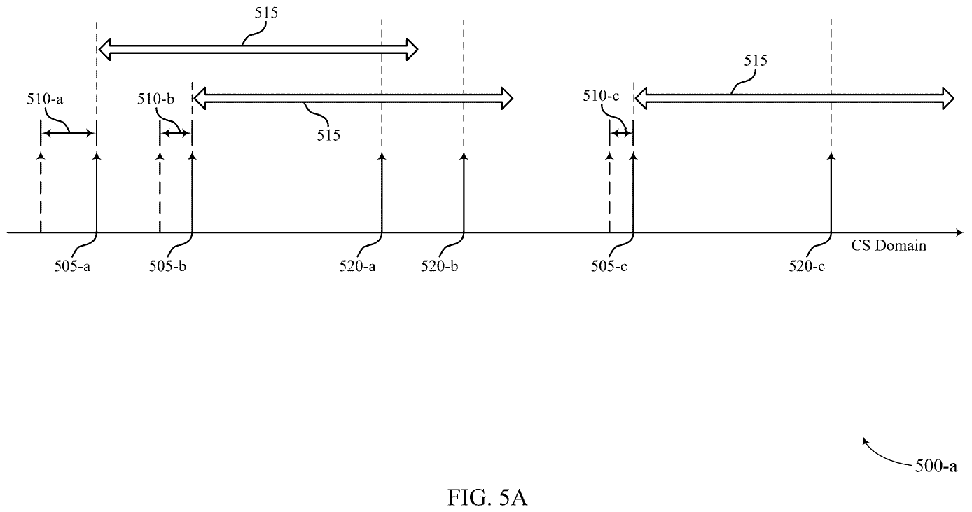

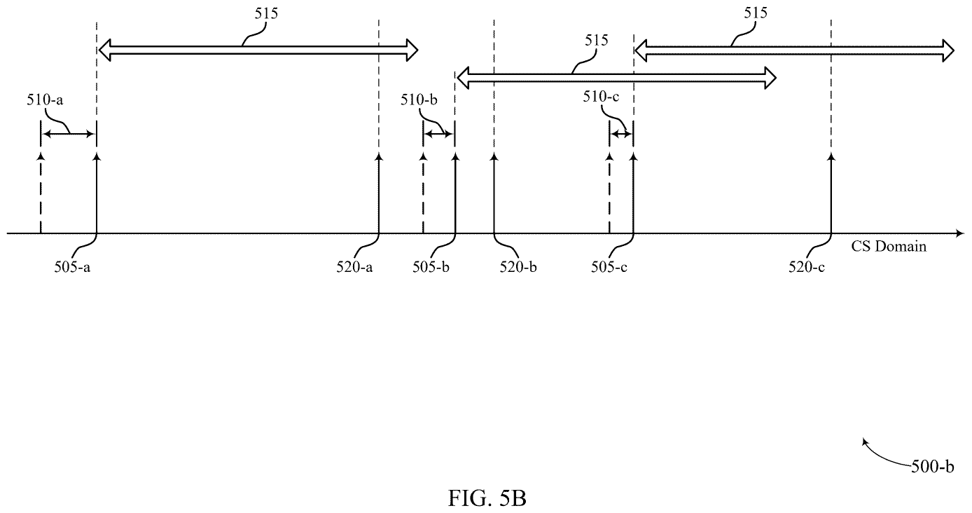

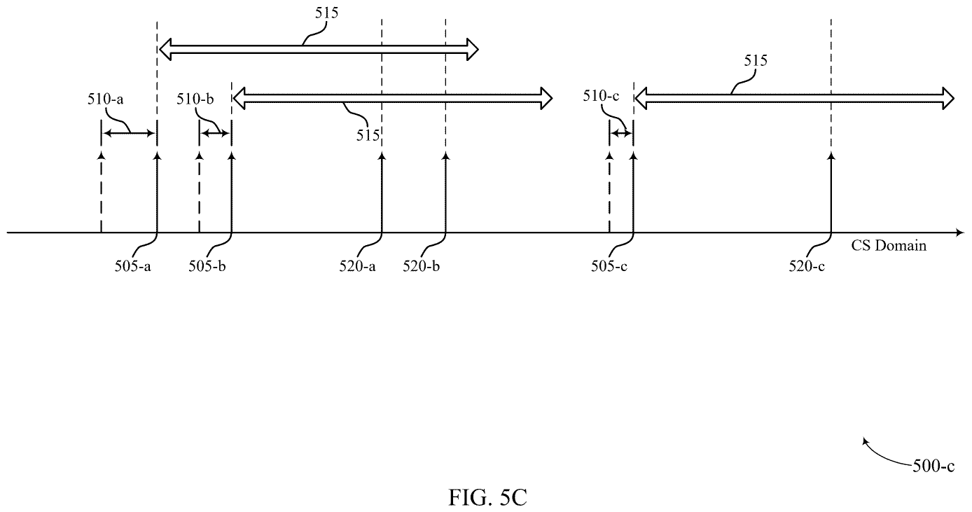

FIGS. 5A, 5B, and 5C show examples of a random access process 500-a, 500-b, and 500-c, respectively, that supports dedicated preamble allocation for random access messages in accordance with one or more aspects of the present disclosure. The random access process 500-a, 500-b, and 500-c may implement, or be implemented by, aspects of the wireless communications system 100, the wireless communications system 200, the random access signaling 300, and the random access process 400, as described with reference to FIGS. 1-4. For example, one or more network entities 105 (which may be an example of a network node) and one or more UEs 115, which may each be examples of corresponding devices described with reference to FIGS. 1-4, may communicate according to the random access process 500-a, 500-b, and 500-c. As an example, the UEs 115 and the network entity 105 may exchange signaling for one or more random access procedures. Although described with reference to a four-step random access procedure, techniques described herein may be similarly applied to any random access procedure (e.g., a two-step random access procedure).

Multiple UEs 115 may randomly select a preamble (e.g., a RACH preamble) and a cyclic shift 505, and may apply a random dithering for transmitting a random access message (e.g., Msg 1). For example, each UE 115 may apply cyclic shift dithering 510 to the selected cyclic shift 505 and transmit the random access message using the cyclic shift 505 after the dithering is applied. For instance, a first UE 115 may apply cyclic shift dithering 510-a to a cyclic shift 505-a, which may be transmitted via a first random access message (e.g., Msg 1). Likewise, a second UE 115 may apply cyclic shift dithering 510-b to a second cyclic shift 505-b and transmit a second random access message, and a third UE 115 may apply cyclic shift dithering 510-c to a third cyclic shift 505-c and transmit a third random access message. In some examples, the UEs 115 may select a same preamble and cyclic shift, which has the potential to result in a collision.

Based on the cyclic shifts 505 transmitted by the respective UEs 115, a network entity 105 may detect one or more paths 520 (e.g., random access paths) that may each correspond to one of the cyclic shifts 505. As an example, the network entity 105 may detect a first path 520-a, a second path 520-b, and a third path 520-c. Based on the detected paths 520, the network entity 105 may determine whether the paths 520 correspond to one or more transmissions of a random access preamble. In some cases, however, the network entity 105 may detect a possible collision between two or more paths 520. For example, as shown by the examples of FIG. 5A, the first path 520-a and the second path 520-b may occur within a cyclic shift step size, within an RTT threshold, and/or within a maximum RTT duration of each other. As such, the network entity 105 may be unable to resolve a collision between at least the first path 520-a and the second path 520-b. In other examples, the path 520-c may occur outside of a cyclic shift step size, an RTT threshold, and/or a maximum RTT duration of one or more other cyclic shifts 505 detected by the network entity 105. In such cases, the network entity 105 may determine that there is no conflict (or that a conflict is unlikely) for the third path 520-c.

After detecting the paths 520 (and any possible collisions), the network entity 105 may transmit path information including a list of all detected cyclic shifts 505 (e.g., all detected cyclic shifts in a root sequence), and the network entity 105 may further allocate a set of contention-based resources, a set of contention-free resources, or an uplink grant (e.g., Msg 3 resource) for each detected path 420. For instance, in accordance with the examples shown in FIG. 5A, the network entity 105 may simultaneously allocate a set of dedicated contention-based resources and/or a set of dedicated contention-free resources to at least the second path 520-b and/or the first path 520-a (e.g., based on a potential conflict for one or both of the first path 520-a or the second path 520-b). The network entity 105 may further allocate an uplink grant to the third path 520-c (e.g., based on the absence of a collision for the third path 520-c).

The path information may be transmitted to multiple UEs 115 via a random access response (e.g., Msg 2) and/or via another message (e.g., Msg X). After receiving the message including the path information (e.g., the list of detected cyclic shifts), each UE 115 may determine if there are any detected paths 520 within its own transmitted cyclic shift 505 plus a threshold duration 515 (e.g., threshold RTT, maximum RTT).

As an example, the first UE 115 may determine whether any of the paths 520 indicated in the path information are within a threshold duration 515 of the cyclic shift 505-a. If so (e.g., if the first UE 115 determines that the path 520-a is within the threshold duration 515, as illustrated in FIG. 5A), the first UE 115 may determine that the first path 520-a is the only path associated with its own cyclic shift 505-a, thereby enabling the first UE 115 to determine that no conflict exists for its cyclic shift 505-a. That is, the first UE 115 may have enough information about its own cyclic shift 505-a (including information about the cyclic shift dithering 510-a applied to the cyclic shift 505-a) to determine that an actual conflict does not exist. In such cases, the first UE 115 may transmit a random access message (e.g., Msg Y) using a set of contention-free resources (e.g., CFRA resources) allocated to the first path 520-a, where the resource allocation for the first path 520-a may be indicated via the path information signaled to the first UE 115. In this case, the first UE 115 determines only the single detected path 520-a corresponding to the cyclic shift 505-a. But because the network entity 105 may not allocate the uplink grant (e.g., Msg 3 resource) to that path 520-a, the first UE 115 may transmit the random access message using the contention-free resource corresponding to the path 520-a (e.g., the first UE 115 transmit via a dedicated CFRA resource corresponding to the detected path 520-a).

In a similar example, if the third UE 115 determines that the path 520-c is the only path 520 within the threshold duration 515, as illustrated in FIG. 5A, the third UE 115 may determine that the path 520-c is the path associated with its own cyclic shift 505-c. The third UE 115 may determine that no conflict exists for its cyclic shift 505-c (which may be consistent with the determination by the network entity 105 that there are no conflicts for the third path 520-c), and the third UE 115-c may transmit a random access message (e.g., Msg 3) using the uplink grant allocated to the third path 520-c. Thus, when the third UE 115 determines that only one detected path (e.g., the third path 520-c) is within the threshold duration 515 of its own cyclic shift 505-c, and a Msg 3 resource is allocated for the detected path, the third UE 115 may proceed with transmitting a random access message (Msg 3) using resources indicated by the uplink grant.

In some cases, the second UE 115 may determine that both the first path 520-a and the second path 520-b are within the threshold duration 515 of its cyclic shift 505-b, as illustrated by FIG. 5A. In such cases, the second UE 115 may be unable to resolve the potential collision based on information associated with its own cyclic shift 505-b. The second UE 115 may accordingly transmit a random access message (e.g., Msg Y) using the contention-based resources that are allocated to the second path 520-b and/or the first path 520-a. In such cases, using the dedicated resource assignment (e.g., dedicated preamble assignment, CBRA resources) for transmitting Msg Y, one or more UEs 115 may transmit Msg Y using the contention-based resources, but there may be relatively fewer collisions for the Msg Y transmitted using the contention-based resources (e.g., compared to some other techniques in which all UEs 115 may transmit Msg Y via the same resources).

Thus, as shown in FIG. 5A, the first UE 115 may transmit a Msg Y using a CFRA resource allocated to the detected path 520-a, the second UE 115 may transmit a Msg Y using CBRA resources, and the third UE 115 may transmit a Msg 3 using resources (e.g., an uplink grant) allocated for the detected path 520-c.

Additionally, or alternatively, the path information may exclude any paths 520 that may correspond to a cyclic shift transmitted by a UE 115. As an example, a fourth UE 115 may determine that its own cyclic shift 505 is not included in the path information signaled by the network entity 105. In such cases, the fourth UE 115 may retransmit a random access message (e.g., Msg 1, Msg A) in a next RO.

FIG. 5B illustrates another scenario in which the multiple UEs 115 transmit cyclic shifts 505, and the network entity 105 may detect respective paths 520 that may correspond to one or more of the cyclic shifts 505. For example, based on the detected paths 520-a, 520-b, and 520-c, the network entity 105 may allocate an uplink grant for the third path 520-c, and allocate both contention-free and contention-based resources to the first path 520-a and to the second path 520-b. For instance, the network entity 105 may determine that there may be a collision for both the first path 520-a and the second path 520-b, and the network entity 105 may simultaneously allocate dedicated contention-free resources and dedicated contention-based resources to both the first path 520-a and the second path 520-b. The indication of the detected paths 520 and the corresponding resource allocation may be signaled to multiple UEs 115 that transmitted random access messages (e.g., respective RACH preambles and cyclic shifts 505).

Accordingly, a first UE 115 may receive the preamble information and may determine that its own cyclic shift 505 (e.g., the first cyclic shift 505-a) is the only cyclic shift 505 within a threshold duration 515 (e.g., threshold RTT) of the first cyclic shift 505-a, and the first UE 115 may accordingly determine that there is no actual collision for the first cyclic shift 505-a. The first UE 115 may therefore select the set of dedicated contention-free resources allocated to the path 520-a for transmitting the random access message (e.g., Msg Y). Similarly, a second UE 115 may receive the preamble information and may determine that its own cyclic shift 505 (e.g., the second cyclic shift 505-b) is the only cyclic shift 505 within a threshold duration 515 (e.g., threshold RTT) of the second cyclic shift 505-b, and the second UE 115 may determine that a collision does not exist for the second cyclic shift 505-b. The second UE 115 may select the set of dedicated contention-free resources allocated to the path 520-b for transmitting the random access message (e.g., Msg Y) based on the determination that there is no collision.

In the example of FIG. 5B, a third UE 115 may receive the path information and determine that path 520-c is the only path 520 within the threshold duration 515 of its own cyclic shift (e.g., the third cyclic shift 505-c). The third UE 115 may determine that no conflict exists for its cyclic shift 505-c (which may be consistent with the determination by the network entity 105 that there are no conflicts for the third path 520-c), and the third UE 115-c may transmit a random access message (e.g., Msg 3) using the uplink grant allocated to the third path 520-c. Thus, when the third UE 115 determines that only one detected path (e.g., the third path 520-c) is within the threshold duration 515 of its own cyclic shift 505-c, and a Msg 3 resource is allocated for the detected path, the third UE 115 may proceed with transmitting a random access message (e.g., Msg 3) using resources indicated by the uplink grant.

Thus, as shown in FIG. 5B, the first UE 115 may transmit a Msg Y using a CFRA resource allocated to the detected path 520-a, the second UE 115 may transmit a Msg Y using a CFRA resource allocated to the detected path 520-b, and the third UE 115 may transmit a Msg 3 using resources (e.g., an uplink grant) allocated for the detected path 520-c.

FIG. 5C illustrates another scenario in which the multiple UEs 115 transmit cyclic shifts 505, and the network entity 105 may detect respective paths 520 that may correspond to one or more of the cyclic shifts 505. For example, based on the detected paths 520-a, 520-b, and 520-c, the network entity 105 may allocate an uplink grant for the third path 520-c, and simultaneously allocate both contention-free and contention-based resources to the first path 520-a and to the second path 520-b. For instance, the network entity 105 may determine that there may be a collision for both the first path 520-a and the second path 520-b, and the network entity 105 may allocate dedicated contention-free resources (e.g., CFRA resources) and dedicated contention-based resources (e.g., CBRA resources) to both the first path 520-a and the second path 520-b. The indication of the detected paths 520 and the corresponding resource allocation may be signaled to multiple UEs 115 that transmitted random access messages (e.g., respective RACH preambles and cyclic shifts 505).

A first UE 115 may receive the preamble information and may determine that its own cyclic shift 505 (e.g., the first cyclic shift 505-a) may be associated with either the path 520-a or the path 520-b within a threshold duration 515 (e.g., threshold RTT) of the first cyclic shift 505-a, and the first UE 115 may accordingly be unable to determine that there is no actual collision for the first cyclic shift 505-a. The first UE 115 may therefore select the set of dedicated contention-based resources allocated to the path 520-a and/or the path 520-b for transmitting the random access message (e.g., Msg Y). That is, because the first UE 115 may detect multiple paths 520 within the threshold duration 515 of its cyclic shift 505-a, the first UE 115 may use Msg Y for additional contention resolution, and may transmit the Msg Y using the contention-based resources.

Similarly, a second UE 115 may receive the preamble information and may determine that its own cyclic shift 505 (e.g., the second cyclic shift 505-b) may correspond to more than one path 520 within a threshold duration 515 (e.g., threshold RTT) of the second cyclic shift 505-b. As such, the second UE 115 may determine that a collision may exist for the second cyclic shift 505-b. The second UE 115 may select the set of dedicated contention-based resources allocated to the path 520-b and/or the path 520-a for transmitting the random access message (e.g., Msg Y) based on the determination that may be a collision associated with its cyclic shift 505-b.

In the example of FIG. 5C, a third UE 115 may receive the path information and determine that path 520-c is the only path 520 within the threshold duration 515 of its own cyclic shift (e.g., the third cyclic shift 505-c). The third UE 115 may determine that no conflict exists for its cyclic shift 505-c (which may be consistent with the determination by the network entity 105 that there are no conflicts for the third path 520-c), and the third UE 115-c may transmit a random access message (e.g., Msg 3) using the uplink grant allocated to the third path 520-c. Thus, when the third UE 115 determines that only one detected path (e.g., the third path 520-c) is within the threshold duration 515 of its own cyclic shift 505-c, and a Msg 3 resource is allocated for the detected path, the third UE 115 may proceed with transmitting a random access message (e.g., Msg 3) using resources indicated by the uplink grant.

Therefore, as shown in FIG. 5C, the first UE 115 may transmit a Msg Y using CBRA resources, the second UE 115 may transmit a Msg Y using CBRA resources, and the third UE 115 may transmit a Msg 3 using resources (e.g., an uplink grant) allocated for the detected path 520-c.

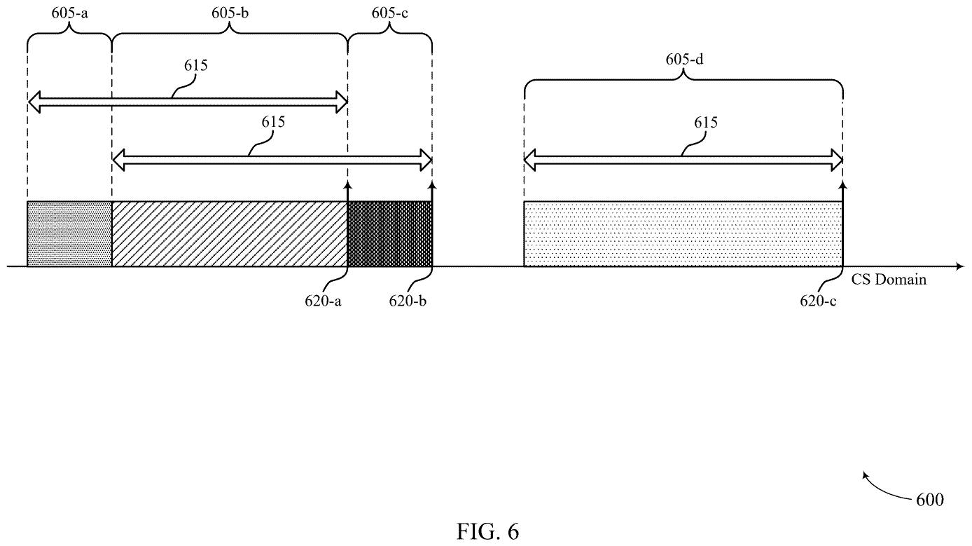

FIG. 6 shows an example of a random access process 600 that supports dedicated preamble allocation for random access messages in accordance with one or more aspects of the present disclosure. The random access process 600 may implement, or be implemented by, aspects of the wireless communications system 100, the wireless communications system 200, the random access signaling 300, and the random access process 400, as described with reference to FIGS. 1-4. For example, one or more network entities 105 (which may be an example of a network node) and one or more UEs 115, which may each be examples of corresponding devices described with reference to FIGS. 1-4, may communicate according to the random access process 600. As an example, the UEs 115 and the network entity 105-c may exchange signaling for one or more random access procedures. Although described with reference to a four-step random access procedure, techniques described herein may be similarly applied to any random access procedure (e.g., a two-step random access procedure).

Multiple UEs 115 may randomly select a preamble (e.g., a RACH preamble) and a cyclic shift, and may apply a random dithering for transmitting a corresponding random access message (e.g., Msg 1). For example, each UE 115 may apply cyclic shift dithering to the selected cyclic shift and transmit the random access message using the cyclic shift having the dithering is applied. For example, a first UE 115 may apply cyclic shift dithering to a cyclic shift, which may be transmitted via a first random access message (e.g., Msg 1). Likewise, a second UE 115 may apply cyclic shift dithering and transmit a second random access message, and a third UE 115 may apply cyclic shift dithering and transmit a third random access message. In some examples, two or more of the UEs 115 may select a same preamble and cyclic shift, which has the potential to result in a collision.

Based on the cyclic shifts transmitted by the respective UEs 115, a network entity 105 may detect one or more paths 620 (e.g., random access paths) that may each correspond to one of the cyclic shifts of the UEs 115. As an example, the network entity 105 may detect a first path 620-a, a second path 620-b, and a third path 620-c. Based on the detected paths 620, the network entity 105 may determine whether the paths 620 correspond to one or more transmissions of a random access preamble by multiple UEs 115. In some cases, however, the network entity 105 may detect a possible collision between two or more paths 620. For example, at least the first path 620-a and the second path 620-b may occur within a cyclic shift step size, an RTT threshold, and/or a maximum RTT duration of each other. As such, the network entity 105 may be unable to resolve a collision between at least the first path 620-a and the second path 620-b. In other examples, the third path 620-c may occur outside of a cyclic shift step size, an RTT threshold, and/or a maximum RTT duration of one or more other cyclic shifts detected by the network entity 105. In such cases, the network entity 105 may determine that there is no conflict (or that a conflict is unlikely) for the third path 620-c.

After detecting the paths 620 (and any possible collisions), the network entity 105 may transmit path information to multiple UEs 115 (e.g., the UEs 115 that transmitted the detected RACH preambles/cyclic shifts). The network entity 105 may further determine (e.g., select, configure, identify) multiple cyclic shift windows 605 (e.g., windows in a cyclic shift domain) for one or more of the detected paths 620. The network entity 105 may further allocate a set of contention-based resources, a set of contention-free resources, or an uplink grant (e.g., Msg 3 resource) for each cyclic shift window 605 of a set of cyclic shift windows.

The network entity 105 may determine the cyclic shift windows 605 corresponding to detected paths 620 based on a threshold duration 615 (e.g., a threshold RTT, a maximum RTT associated with a cell) from each of the detected paths 620. As an example, the network entity 105 may identify at least a first cyclic shift window 605-a, a second cyclic shift window 605-b, a third cyclic shift window 605-c, and a fourth cyclic shift window 605-d. In some examples, a cyclic shift window 605 may correspond to cyclic shift windows 605 that at least partially overlap. As an example, the second cyclic shift window 605-b may correspond to overlapping portions of the first cyclic shift window 605-a and the third cyclic shift window 605-c. As such, the first cyclic shift window 605-a and the second cyclic shift window 605-b may be within the threshold duration 615 from the first path 620-a, and the second cyclic shift window 605-b and the third cyclic shift window 605-c may be within the threshold duration 615 of the second path 620-b. In some examples, the network entity 105 may determine that the fourth cyclic shift window 605-d may be within the threshold duration 615.

Based on the determine cyclic shift windows 605, the network entity 105 may allocate resources to each cyclic shift window 605. For example, the network entity 105 may allocate at least a set of contention-based resources, a set of contention-based resources, an uplink grant, or any combination thereof, to each cyclic shift window 605. That is, the network entity 105 may allocate a set of dedicated contention-based resources or a set of dedicated contention-free resources to at least the first cyclic shift window 605-a, the second cyclic shift window 605-b, the third cyclic shift window 605-c, or any combination thereof (e.g., based on a potential conflict for one or both of the first path 620-a or the second path 620-b). The network entity 105 may further allocate an uplink grant to the third cyclic shift window 605-c (e.g., based on the absence of a collision for the third path 620-c). In such examples, if there are no other cyclic shift windows 605 within the threshold duration (e.g., within a threshold RTT duration) of a detected path, then the network entity 105 may allocate the uplink grant (e.g., uplink resources for Msg 3 may be allocated to the fourth cyclic shift window 605-d). Additionally, if there is a possible collision of cyclic shift windows 605 between detected paths 620, the network entity 105 may allocate the contention-based resources (e.g., CBRA resources) for the overlapping region of the cyclic shift windows 605 (e.g., for the second cyclic shift window 605-b), and the network entity may allocate contention-free resources (e.g., CFRA resources) for one or more non-overlapping regions of overlapping cyclic shift windows 605 (e.g., for the first cyclic shift window 605-a and for the third cyclic shift window 605-c).

The path information may be transmitted to multiple UEs 115 via a random access response (e.g., Msg 2) and/or via another message (e.g., Msg X). The message including the path information may further include and/or indicate allocated resources for each cyclic shift window 605. After receiving the message including the path information (e.g., the indication of the one or more cyclic shift windows 605), each UE 115 may determine, based on information about its own transmitted cyclic shift, which cyclic shift window 605 of the one or more cyclic shift windows 605 correspond to that UE's cyclic shift. The UE 115 may identify a resource allocation corresponding to the identified cyclic shift window 605, and the UE 115 may transmit a random access message using the allocated resources.

In some aspects, Table 1 may illustrate an example of an indication of multiple cyclic shift windows 605 and corresponding messages that are transmitted via allocated resources, the information of which may be indicated via the path information:

TABLE 1

| User Transmitted Cyclic Shift | User transmission |
|---|---|
| First cyclic shift window | Msg Y using CFRA resources |
| Second cyclic shift window | Msg Y using CBRA resources |
| Third cyclic shift window | Msg Y using CFRA resources |
| Fourth cyclic shift window | Msg 3 using uplink grant |

For example, a first UE 115 may determine that a cyclic shift transmitted (e.g., for Msg 1) may be included in the second cyclic shift window 605-b. In accordance with Table 1, the first UE 115 may determine that the second cyclic shift window 605-b is allocated the contention-based resources (e.g., the UE 115 may accordingly determine that a conflict exists for its cyclic shift transmission), and the first UE 115 may transmit a random access message (e.g., Msg Y) using the allocated contention-based resources. In another example, a second UE 115 may determine that a cyclic shift transmitted (e.g., for Msg 1) by the second UE 115 may be included in the first cyclic shift window 605-a. The second UE 115 may use the information conveyed via the path information to determine that the first cyclic shift window 605-a is allocated the contention-free resources (e.g., the second UE 115 may determine that no conflict exists for its cyclic shift), and the second UE 115 may transmit a random access message (e.g., Msg Y) using the allocated contention-free resources. In some examples, a third UE 115 may determine that a cyclic shift transmitted (e.g., for Msg 1) may be included in the fourth cyclic shift window 605-d. In accordance with Table 1, the third UE 115 may determine that the fourth cyclic shift window 605-d is allocated the uplink grant (e.g., the UE 115 may accordingly determine that a conflict does not exist for its cyclic shift transmission), and the first UE 115 may transmit a random access message (e.g., Msg 3) using the allocated resources of the uplink grant.

Thus, in this example, the network entity 105 may transmit an indication of a quantity of different cyclic shift windows 605 (e.g., four cyclic shift windows 605), and each UE 115 may transmit a random access message (e.g., Msg 3, Msg Y) based on the cyclic shift window 605 corresponding to the UE's previous cyclic shift transmission and the resources allocated to the corresponding cyclic shift window 605. In some aspects, each cyclic shift window 605 may be configured as a “collision window” or a “non-collision window,” and the resources allocated for each cyclic shift window 605 may be based on the configuration.

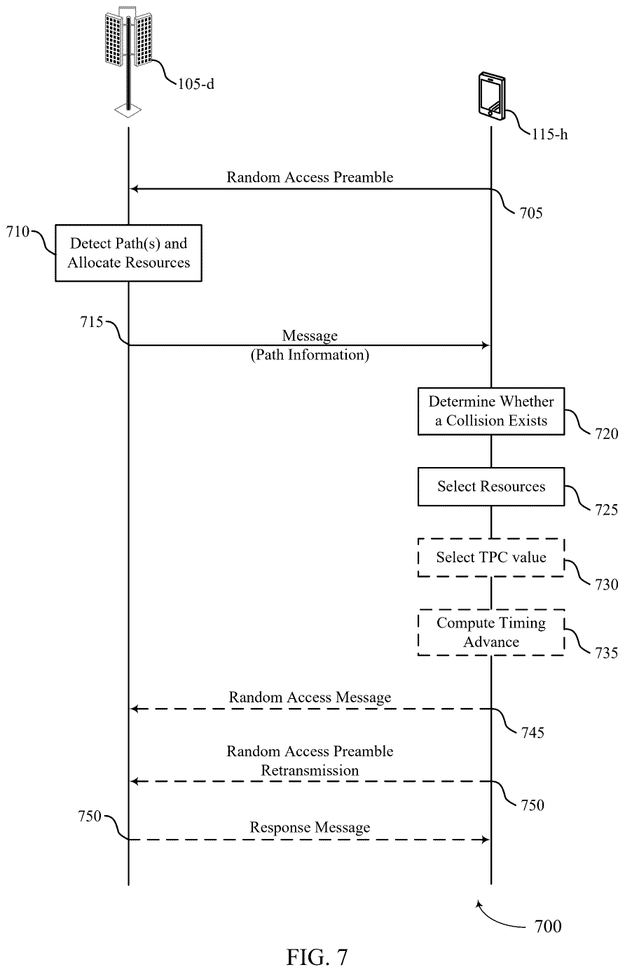

FIG. 7 shows an example of a process flow 700 that supports dedicated preamble allocation for random access messages in accordance with one or more aspects of the present disclosure. The process flow 700 may implement, or be implemented by, aspects of the wireless communications system 100, the wireless communications system 200, the random access signaling 300, the random access process 400, the random access process 500, and the random access process 600. For example, the process flow 700 may include one or more network entities 105 (e.g., network entity 105-d, which may be referred to as a network node), and one or more UEs 115 (e.g., UE 115-h), which may be examples of corresponding devices described with reference to FIGS. 1-6 and may communicate according to the process flow 700. Although illustrated with reference to a four-step random access procedure, techniques described herein may be similarly applied to any random access procedure (e.g., a two-step random access procedure).

Alternative examples of the following may be implemented. For example, some steps may be performed in a different order than described or may not be performed at all. In some implementations, steps may include additional features not mentioned below, or further steps may be added. Further, although the UE 115 and the network entity 105 are shown performing the operations of the process flow 700, some aspects of some operations may also be performed by one or more other wireless communication devices.

At 705, the UE 115-h may transmit, and the network entity 105-d may obtain, a random access message (e.g., Msg 1) that may include a random access preamble (e.g., a RACH preamble). For example, the UE 115-h may attempt to access a network and transmit the random access message. In some examples, one or more other UEs 115 may also transmit a same random access preamble (e.g., using a same RO). In such cases, a collision may occur with a cyclic shift transmitted by the UE 115-h at 705 and one or more other cyclic shifts associated with respective preamble transmissions by the other UEs 115.

At 710, the network entity 105-d may detect multiple paths associated with the random access preambles transmitted by multiple UEs 115 (e.g., including the UE 115-h). In some cases, each path may correspond to a cyclic shift transmitted by a UE 115 in a random access message (e.g., Msg 1). The network entity 105-d may further determine whether any possible collisions exist for the detected paths. For example, the network entity 105-d may detect a possible collision for the path based on set of multiple random access preambles.

In some examples, the network entity 105-d may allocate resources for each path of the detected paths based on whether a collision was detected by the network entity 105-d. Additionally, or alternatively, the network entity 105-d may determine a set of cyclic shift windows that correspond to the detected paths, and the network entity 105-d may allocate resources for each cyclic shift window based on whether the window may be associated with a collision.

At 715, the network entity 105-d may output, and the UE 115-h may receive, a message that indicates path information for the random access preambles detected by the network node (e.g., the detected paths). In some cases, the message further indicates, for each path corresponding to the random access preambles, a set of allocated resources including at least a first set of resources, a second set of resources, or an uplink grant, or a combination thereof. The first set of resources may correspond to contention-based random access resources and the second set of resources may correspond to contention-free random access resources.

At 720, the UE 115-h may determine, for a path associated with a first random access preamble transmitted by the UE 115-h, whether a collision exists for the first random access preamble (e.g., whether a collision exists for a cyclic shift), where the determination may be based on the path information and an RTT associated with the first random access preamble.

In some examples, the path information includes a list of cyclic shifts associated with the random access preambles detected by the network entity 105-d, and the UE 115-h may determine that the path associated with the first random access preamble (e.g., transmitted by the UE 115-h) is indicated by the path information based on the RTT and a cyclic shift associated with the first random access preamble included in the list of cyclic shifts. In some aspects, determining whether the collision exists may be based on a quantity of paths associated with the cyclic shift and the RTT (e.g., threshold RTT). Alternatively, the UE 115-h may determine an absence of the collision for the first random access preamble based on a single path being associated with the cyclic shift and the RTT. In such cases, the path may be allocated the uplink grant (e.g., if the network entity 105-d also determined that the collision does not exist) or the path may be simultaneously allocated the contention-free random access resources and the contention-based random access resources (e.g., if the network entity 105-d was unable to determine that a collision for the path does not exist). In some examples, the UE 115-d may determine that the random access preamble is not included in the preamble information.

Additionally, or alternatively, the path information may include a set of cyclic shift windows associated with the random access preambles (e.g., the detected paths), and the UE 115-h may determine that the path associated with the first random access preamble is indicated by the path information based on the RTT and based on a cyclic shift associated with the first random access preamble being included in a cyclic shift window of the set of cyclic shift windows. As such, determining whether the collision exists is based on the cyclic shift window that includes the cyclic shift. For example, the UE 115-h may determine an absence of the collision for the first random access preamble based on the cyclic shift window being associated with an absence of collisions. In other examples, the UE 115-h may determine that the collision exists for the first random access preamble based on the cyclic shift window being associated with one or more collisions.

At 725, the UE 115-h may select a set of resources based on whether the UE 115-h determined whether a collision exists for the first random access preamble. For example, when the path information includes the list of cyclic shifts, the UE 115-h may use the resources allocated to the path that corresponds to the first cyclic shift. For instance, if the path is allocated both the contention-based random access resources and the contention-free random access resources, the UE 115-h may select either the contention-based random access resources or the contention-free random access resources based on whether the collision is identified by the UE 115-h. In other examples, the UE 115-h may select the resources of the uplink grant when the path associated with the first random access preamble is allocated the uplink grant. Likewise, when the path information includes the cyclic shift windows, the UE 115-h may select the resources of a window corresponding to the first random access preamble transmitted by the UE 115-h.

In some aspects, at 730, the UE 115-h may select a TPC value for transmitting a random access message, where the TPC value may be selected based on the path associated with the first random access preamble, whether the collision was detected, and/or the resources selected by the UE 115-h.

At 735, the UE 115-h may optionally compute (e.g., determine, calculate) a TA value for transmitting a random access message, where the TA value may be computed based on a difference between a cyclic shift indicated by the path information and a first cyclic shift associated with the first random access preamble. In some cases, the TA value may be computed based on the path associated with the first random access preamble, whether the collision was detected, and/or the resources selected by the UE 115-h.

At 745, the UE 115-h may transmit, and the network entity 105-d may obtain, a random access message including a second random access preamble. The random access message may be transmitted using the first set of resources, or the second set of resources, or the uplink grant, where the first set of resources, or the second set of resources, or the uplink grant may be used for the random access message based on whether the collision exists for the path. As an example, if no collision exists for the path, the UE 115-h may use the second set of resources or the uplink grant for the random access message. In other examples, the UE 115-h may use the first set of resources if a collision exists for the path.

In some examples, the UE 115-h may apply the timing advance value to the random access message in a time domain, where a cyclic shift corresponding to the second random access preamble corresponds to an allocated cyclic shift of the second set of resources. Additionally, or alternatively, the UE 115-h may apply the timing advance value to the random access message in a cyclic shift domain, where a cyclic shift corresponding to the second random access preamble is based on a difference between the timing advance value and an allocated cyclic shift of the second set of resources.

At 745, the UE 115-h may transmit, and the network entity 105-d may obtain, a retransmission of a first random access message based on the path information excluding one or more paths associated with the first random access preamble, the RTT associated with the first random access preamble, or both. That is, if the path is not included in the path information, the UE 115-h may retransmit the first random access message (e.g., Msg 1).

At 750, the network entity 105-d may output, and the UE 115-h may receive, a response message including at least a TA value, a TPC value, and one or more resources for an uplink transmission, or any combination thereof. In some examples, the response message may be received based on the UE 115-h selecting the contention-based random access resources for transmitting the random access message at 740.

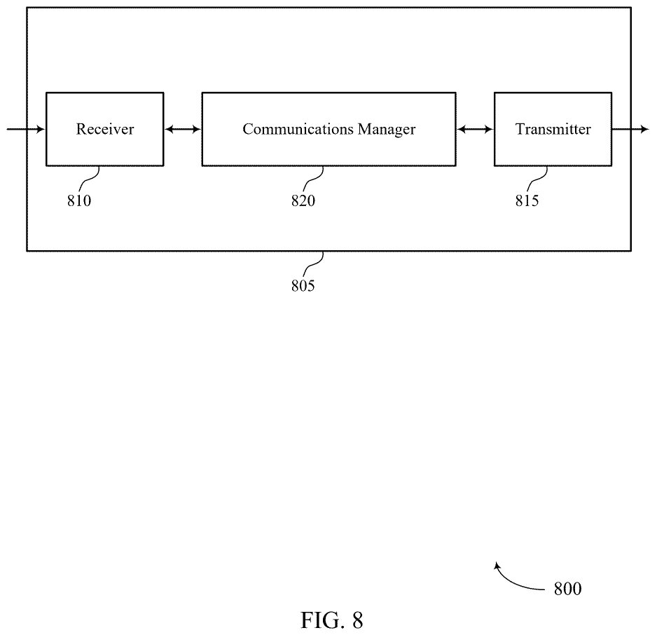

FIG. 8 shows a block diagram 800 of a device 805 that supports dedicated preamble allocation for random access messages in accordance with one or more aspects of the present disclosure. The device 805 may be an example of aspects of a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, and instructions stored in the at least one memory that are executable by the one or more processors to enable the one or more processors to perform techniques for dedicated preamble allocation for random access messages features discussed herein. Each of these components may be in communication with one another (e.g., via one or more buses).

The receiver 810 may provide a means for receiving information such as packets, user data, control information, or any combination thereof associated with various information channels (e.g., control channels, data channels, information channels related to dedicated preamble allocation for random access messages). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to dedicated preamble allocation for random access messages). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations or components thereof may be examples of means for performing various aspects of dedicated preamble allocation for random access messages as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for receiving, from a network node (such as a network entity 105), a message indicating path information for random access preambles detected by the network node, where the message further indicates, for each path corresponding to the random access preambles, a set of allocated resources including at least a first set of resources, a second set of resources, or an uplink grant, and where the first set of resources corresponds to contention-based random access resources and the second set of resources corresponds to contention-free random access resources. The communications manager 820 is capable of, configured to, or operable to support a means for determining, for a path associated with a first random access preamble transmitted by the UE, whether a collision exists for the first random access preamble, where the determination is based on the path information and a round trip time associated with the first random access preamble. The communications manager 820 is capable of, configured to, or operable to support a means for transmitting a random access message including a second random access preamble using the first set of resources, or the second set of resources, or the uplink grant, where the first set of resources, or the second set of resources, or the uplink grant is used for the random access message based on whether the collision exists for the path.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced processing, reduced power consumption, and more efficient utilization of communication resources, among other advantages. As an example, the device 805 may select resources based on information regarding a previously-transmitted random access preamble, where the resources may correspond to contention-free or contention-based resources. In such cases, the selection of either the contention-free or contention-based resources may enable improved efficiency in random access contention resolution, thereby reducing processing and improving resource utilization.

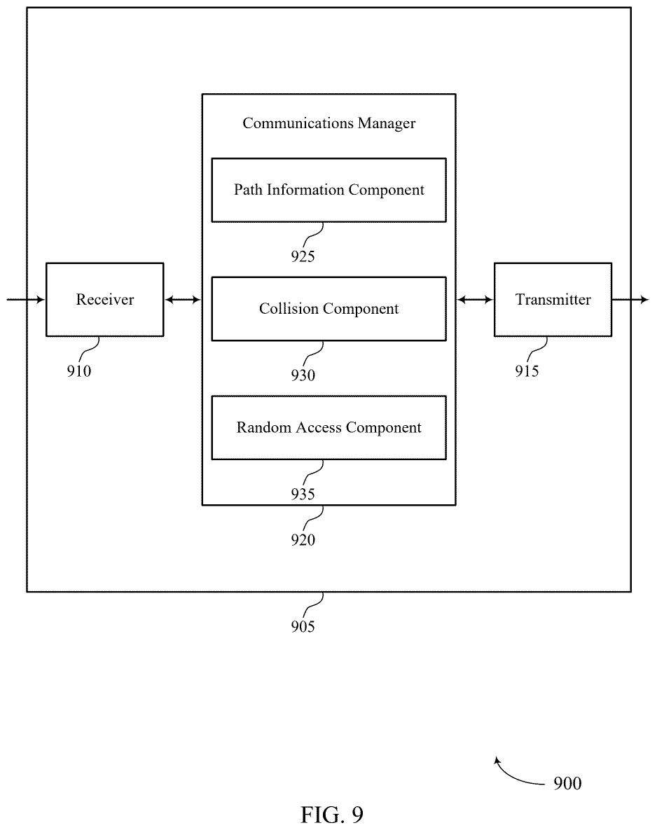

FIG. 9 shows a block diagram 900 of a device 905 that supports dedicated preamble allocation for random access messages in accordance with one or more aspects of the present disclosure. The device 905 may be an example of aspects of a device 805 or a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to dedicated preamble allocation for random access messages). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to dedicated preamble allocation for random access messages). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of dedicated preamble allocation for random access messages as described herein. For example, the communications manager 920 may include a path information component 925, a collision component 930, a random access component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The path information component 925 is capable of, configured to, or operable to support a means for receiving, from a network node (e.g., a network entity), a message indicating path information for random access preambles detected by the network node, where the message further indicates, for each path corresponding to the random access preambles, a set of allocated resources including at least a first set of resources, a second set of resources, or an uplink grant, and where the first set of resources corresponds to contention-based random access resources and the second set of resources corresponds to contention-free random access resources. The collision component 930 is capable of, configured to, or operable to support a means for determining, for a path associated with a first random access preamble transmitted by the UE, whether a collision exists for the first random access preamble, where the determination is based on the path information and a round trip time associated with the first random access preamble. The random access component 935 is capable of, configured to, or operable to support a means for transmitting a random access message including a second random access preamble using the first set of resources, or the second set of resources, or the uplink grant, where the first set of resources, or the second set of resources, or the uplink grant is used for the random access message based on whether the collision exists for the path.

In some cases, the path information component 925, the collision component 930, and/or the random access component 935 may each be or be at least a part of a processor (e.g., a transceiver processor, or a radio processor, or a transmitter processor, or a receiver processor). The processor may be coupled with at least one memory and execute instructions stored in the memory that enable the processor to perform or facilitate the features of the path information component 925, the collision component 930, and/or the random access component 935 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

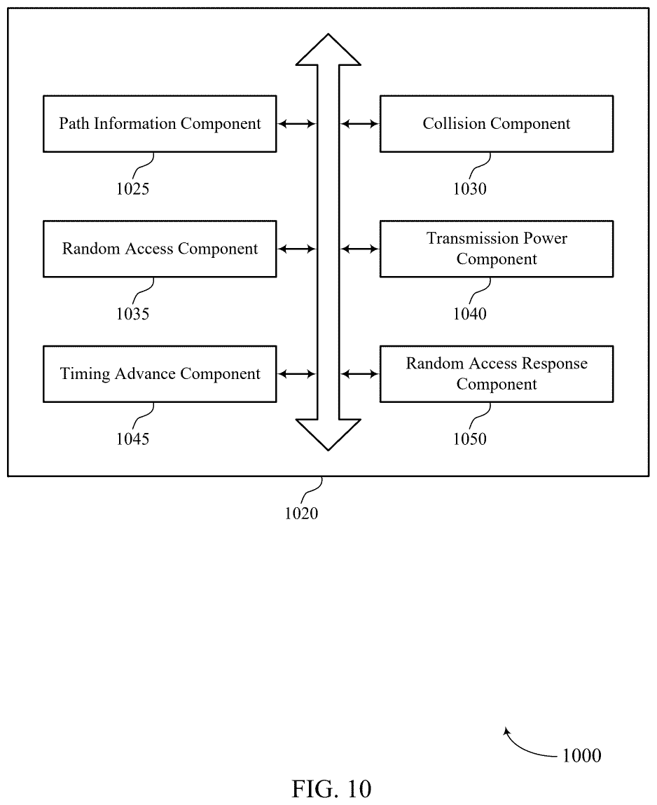

FIG. 10 shows a block diagram 1000 of a communications manager 1020 that supports dedicated preamble allocation for random access messages in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of dedicated preamble allocation for random access messages as described herein. For example, the communications manager 1020 may include a path information component 1025, a collision component 1030, a random access component 1035, a transmission power component 1040, a timing advance component 1045, a random access response component 1050, or any combination thereof. Each of these components, or components or subcomponents thereof (e.g., one or more processors, one or more memories), may communicate, directly or indirectly, with one another (e.g., via one or more buses).

The communications manager 1020 may support wireless communications in accordance with examples as disclosed herein. The path information component 1025 is capable of, configured to, or operable to support a means for receiving, from a network node (such as a network entity), a message indicating path information for random access preambles detected by the network node, where the message further indicates, for each path corresponding to the random access preambles, a set of allocated resources including at least a first set of resources, a second set of resources, or an uplink grant, and where the first set of resources corresponds to contention-based random access resources and the second set of resources corresponds to contention-free random access resources. The collision component 1030 is capable of, configured to, or operable to support a means for determining, for a path associated with a first random access preamble transmitted by the UE, whether a collision exists for the first random access preamble, where the determination is based on the path information and a round trip time associated with the first random access preamble. The random access component 1035 is capable of, configured to, or operable to support a means for transmitting a random access message including a second random access preamble using the first set of resources, or the second set of resources, or the uplink grant, where the first set of resources, or the second set of resources, or the uplink grant is used for the random access message based on whether the collision exists for the path.

In some examples, the path information includes a list of cyclic shifts associated with the random access preambles, and the path information component 1025 is capable of, configured to, or operable to support a means for determining that the path associated with the first random access preamble is indicated by the path information based on the round trip time and a cyclic shift associated with the first random access preamble included in the list of cyclic shifts, where determining whether the collision exists is based on a quantity of paths associated with the cyclic shift and the round trip time.

In some examples, to support determining whether the collision exists for the first random access preamble, the collision component 1030 is capable of, configured to, or operable to support a means for determining an absence of the collision for the first random access preamble based on a single path being associated with the cyclic shift and the round trip time, where the random access message is transmitted using the uplink grant based on the single path being associated with the cyclic shift and the round trip time and in accordance with the message allocating the uplink grant for the single path.

In some examples, to support determining whether the collision exists for the first random access preamble, the collision component 1030 is capable of, configured to, or operable to support a means for determining an absence of the collision for the first random access preamble based on a single path being associated with the cyclic shift and the round trip time, where the random access message is transmitted using the second set of resources based on the single path being associated with the cyclic shift and the round trip time and in accordance with the message allocating the second set of resources for the single path.

In some examples, to support determining whether the collision exists for the first random access preamble, the collision component 1030 is capable of, configured to, or operable to support a means for determining that the collision exists for the first random access preamble based on multiple paths being associated with the cyclic shift and the round trip time, where the random access message is transmitted using the first set of resources based on the multiple paths being associated with the cyclic shift and the round trip time and in accordance with the message indicating that the first set of resources is allocated for at least one of the multiple paths.

In some examples, the random access component 1035 is capable of, configured to, or operable to support a means for retransmitting a first random access message based on the cyclic shift being excluded from the list of cyclic shifts.

In some examples, the cyclic shift is adjusted by the UE based on a cyclic shift offset. In some examples, determining whether the collision exists is based on cyclic shift and the cyclic shift offset.

In some examples, the path information includes a set of cyclic shift windows associated with the random access preambles, and the path information component 1025 is capable of, configured to, or operable to support a means for determining that the path associated with the first random access preamble is indicated by the path information based on the round trip time and based on a cyclic shift associated with the first random access preamble being included in a cyclic shift window of the set of cyclic shift windows, where determining whether the collision exists is based on the cyclic shift window that includes the cyclic shift.

In some examples, to support determining whether the collision exists for the first random access preamble, the collision component 1030 is capable of, configured to, or operable to support a means for determining an absence of the collision for the first random access preamble based on the cyclic shift window being associated with an absence of collisions, where the random access message is transmitted using the uplink grant in accordance with the message allocating the uplink grant for the cyclic shift window.

In some examples, to support determining whether the collision exists for the first random access preamble, the collision component 1030 is capable of, configured to, or operable to support a means for determining an absence of the collision for the first random access preamble based on the cyclic shift window being associated with an absence of collisions, where the random access message is transmitted using the second set of resources in accordance with the message allocating the second set of resources for the cyclic shift window.

In some examples, to support determining whether the collision exists for the first random access preamble, the collision component 1030 is capable of, configured to, or operable to support a means for determining that the collision exists for the first random access preamble based on the cyclic shift window being associated with one or more collisions, where the random access message is transmitted using the first set of resources in accordance with the message allocating the first set of resources for the cyclic shift window.

In some examples, the random access component 1035 is capable of, configured to, or operable to support a means for retransmitting a first random access message based on the path information excluding one or more paths associated with the first random access preamble, the round trip time associated with the first random access preamble, or both.

In some examples, the transmission power component 1040 is capable of, configured to, or operable to support a means for selecting a transmission power control value for transmitting the random access message based on the path associated with the first random access preamble, where the random access message is transmitted using the second set of resources.

In some examples, the timing advance component 1045 is capable of, configured to, or operable to support a means for computing a timing advance value for transmitting the random access message based on a difference between a cyclic shift indicated by the path information and a first cyclic shift associated with the first random access preamble, the first cyclic shift having a cyclic shift offset applied, where the random access message is transmitted using the second set of resources.

In some examples, the timing advance component 1045 is capable of, configured to, or operable to support a means for applying the timing advance value to the random access message in a time domain, where a cyclic shift corresponding to the second random access preamble corresponds to an allocated cyclic shift of the second set of resources.

In some examples, the timing advance component 1045 is capable of, configured to, or operable to support a means for applying the timing advance value to the random access message in a cyclic shift domain, where a cyclic shift corresponding to the second random access preamble is based on a difference between the timing advance value and an allocated cyclic shift of the second set of resources.

In some examples, the random access message is transmitted using a first timing advance and a first transmission power control value that respectively correspond to a second timing advance and a second transmission power control value used for transmitting the first random access preamble. In some examples, the random access message is transmitted using the first set of resources.

In some examples, the random access response component 1050 is capable of, configured to, or operable to support a means for receiving, from the network node and based on the random access message, a response message including at least a timing advance, a transmission power control value, and one or more resources for an uplink transmission, or any combination thereof, where the random access message is transmitted using the first set of resources.

In some examples, the random access response component 1050 is capable of, configured to, or operable to support a means for receiving, from the network node and based on the random access message, a response message including one or more resources for an uplink transmission, where the random access message is transmitted using the second set of resources.

In some examples, the first set of resources is associated with one or more parameters that are different from one or more parameters associated with the second set of resources, the one or more parameters including at least a set of candidate cyclic shifts, a set of root sequences, one or more ROs, a cyclic shift step size, or any combination thereof.

In some cases, the path information component 1025, the collision component 1030, the random access component 1035, the transmission power component 1040, the timing advance component 1045, and the random access response component 1050 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the path information component 1025, the collision component 1030, the random access component 1035, the transmission power component 1040, the timing advance component 1045, and the random access response component 1050 discussed herein.

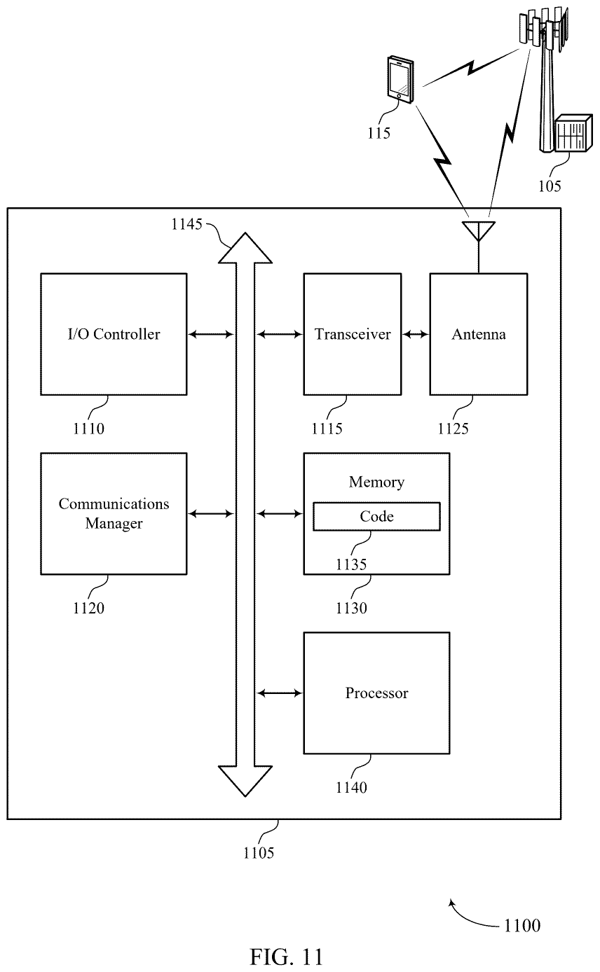

FIG. 11 shows a diagram of a system 1100 including a device 1105 that supports dedicated preamble allocation for random access messages in accordance with one or more aspects of the present disclosure. The device 1105 may be an example of or include components of a device 805, a device 905, or a UE 115 as described herein. The device 1105 may communicate (e.g., wirelessly) with one or more other devices (e.g., network entities 105, UEs 115, or a combination thereof). The device 1105 may include components for bi-directional voice and data communications including components for transmitting and receiving communications, such as a communications manager 1120, an input/output (I/O) controller, such as an I/O controller 1110, a transceiver 1115, one or more antennas 1125, at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna. However, in some other cases, the device 1105 may have more than one antenna, which may be capable of concurrently transmitting or receiving multiple wireless transmissions. The transceiver 1115 may communicate bi-directionally via the one or more antennas 1125 using wired or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable, or processor-executable code, such as the code 1135. The code 1135 may include instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may include, among other things, a basic I/O system (BIOS) which may control basic hardware or software operation such as the interaction with peripheral components or devices.

The at least one processor 1140 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting dedicated preamble allocation for random access messages). For example, the device 1105 or a component of the device 1105 may include at least one processor 1140 and at least one memory 1130 coupled with or to the at least one processor 1140, the at least one processor 1140 and the at least one memory 1130 configured to perform various functions described herein.

In some examples, the at least one processor 1140 may include multiple processors and the at least one memory 1130 may include multiple memories. One or more of the multiple processors may be coupled with one or more of the multiple memories, which may, individually or collectively, be configured to perform various functions described herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. For example, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code 1135 (e.g., processor-executable code) stored in the at least one memory 1130 or otherwise, to perform one or more of the functions described herein.

The communications manager 1120 may support wireless communications in accordance with examples as disclosed herein. For example, the communications manager 1120 is capable of, configured to, or operable to support a means for receiving, from a network node, a message indicating path information for random access preambles detected by the network node, where the message further indicates, for each path corresponding to the random access preambles, a set of allocated resources including at least a first set of resources, a second set of resources, or an uplink grant, and where the first set of resources corresponds to contention-based random access resources and the second set of resources corresponds to contention-free random access resources. The communications manager 1120 is capable of, configured to, or operable to support a means for determining, for a path associated with a first random access preamble transmitted by the UE, whether a collision exists for the first random access preamble, where the determination is based on the path information and a round trip time associated with the first random access preamble. The communications manager 1120 is capable of, configured to, or operable to support a means for transmitting a random access message including a second random access preamble using the first set of resources, or the second set of resources, or the uplink grant, where the first set of resources, or the second set of resources, or the uplink grant is used for the random access message based on whether the collision exists for the path.

By including or configuring the communications manager 1120 in accordance with examples as described herein, the device 1105 may support techniques for improved communication reliability, reduced latency, improved user experience related to reduced processing, reduced power consumption, more efficient utilization of communication resources, and improved coordination between devices, among other examples. In some cases, the device 1105 may select resources based on information regarding a previously-transmitted random access preamble, where the resources may correspond to contention-free or contention-based resources. In such cases, the selection of either the contention-free or contention-based resources may enable improved efficiency in random access contention resolution, thereby reducing processing and improving resource utilization and further reducing latency associated with random access procedures.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of dedicated preamble allocation for random access messages as described herein, or the at least one processor 1140 and the at least one memory 1130 may be otherwise configured to, individually or collectively, perform or support such operations.

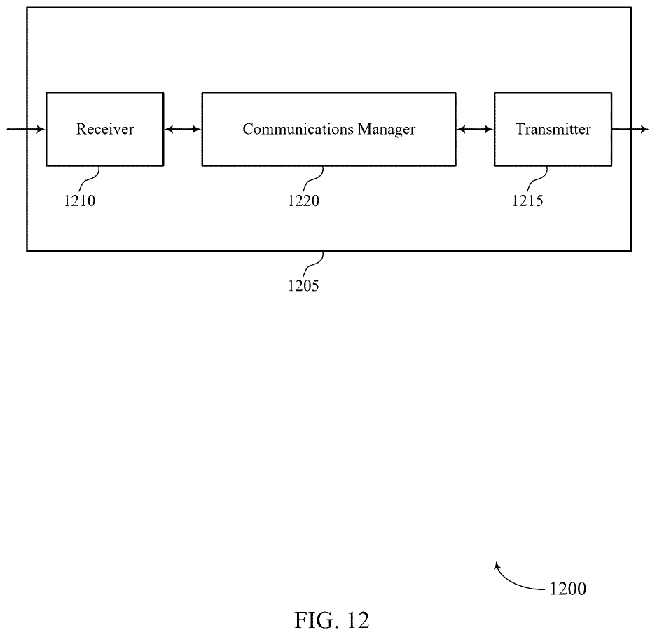

FIG. 12 shows a block diagram 1200 of a device 1205 that supports dedicated preamble allocation for random access messages in accordance with one or more aspects of the present disclosure. The device 1205 may be an example of aspects of a network entity 105 (e.g., a network node) as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, and instructions stored in the at least one memory that are executable by the one or more processors to enable the one or more processors to perform techniques for dedicated preamble allocation for random access messages features discussed herein. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations or components thereof may be examples of means for performing various aspects of dedicated preamble allocation for random access messages as described herein. For example, the communications manager 1220, the receiver 1210, the transmitter 1215, or various combinations or components thereof may be capable of performing one or more of the functions described herein.

In some examples, the communications manager 1220, the receiver 1210, the transmitter 1215, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1220, the receiver 1210, the transmitter 1215, or various combinations or components thereof may be implemented in code (e.g., as communications management software or firmware) executed by at least one processor (e.g., referred to as a processor-executable code). If implemented in code executed by at least one processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. For example, the communications manager 1220 is capable of, configured to, or operable to support a means for obtaining a set of multiple random access preambles from a set of multiple user equipment (UEs), where each random access preamble of the set of multiple random access preambles is associated with a respective UE. The communications manager 1220 is capable of, configured to, or operable to support a means for outputting a message indicating path information for the set of multiple random access preambles, where the message further indicates, for each path corresponding to the set of multiple random access preambles, a set of allocated resources including at least a first set of resources, a second set of resources, or an uplink grant, and where the first set of resources corresponds to contention-based random access resources and the second set of resources corresponds to contention-free random access resources. The communications manager 1220 is capable of, configured to, or operable to support a means for obtaining, from a UE of the set of multiple UEs, a random access message including a first random access preamble using the first set of resources, or the second set of resources, or the uplink grant, where obtaining the random access message using the first set of resources, or the second set of resources, or the uplink grant is based on whether a collision exists for a path associated with a second random access preamble of the set of multiple random access preambles.

By including or configuring the communications manager 1220 in accordance with examples as described herein, the device 1205 (e.g., at least one processor controlling or otherwise coupled with the receiver 1210, the transmitter 1215, the communications manager 1220, or a combination thereof) may support techniques for reduced processing, reduced power consumption, more efficient utilization of communication resources (e.g., including reduced signaling), among other examples. In some cases, resources selected by another device (e.g., a UE) may inform the device 1205 whether a collision exists for a random access preamble transmission, which may enable faster contention resolution for random access procedures.

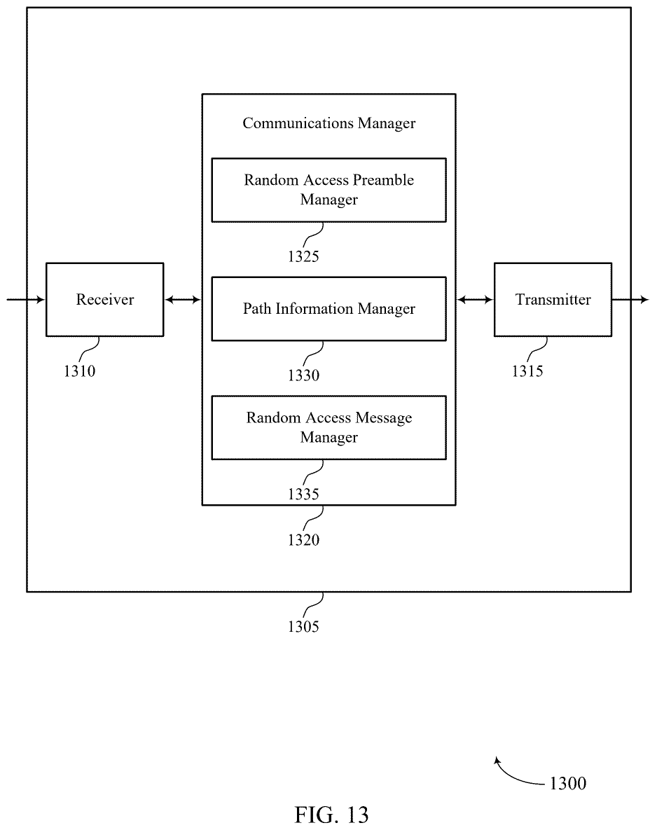

FIG. 13 shows a block diagram 1300 of a device 1305 that supports dedicated preamble allocation for random access messages in accordance with one or more aspects of the present disclosure. The device 1305 may be an example of aspects of a device 1205, a network node, or a network entity 105 as described herein. The device 1305 may include a receiver 1310, a transmitter 1315, and a communications manager 1320. The device 1305, or one or more components of the device 1305 (e.g., the receiver 1310, the transmitter 1315, the communications manager 1320), may include at least one processor, which may be coupled with at least one memory, to support the described techniques. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of dedicated preamble allocation for random access messages as described herein. For example, the communications manager 1320 may include a random access preamble manager 1325, a path information manager 1330, a random access message manager 1335, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications in accordance with examples as disclosed herein. The random access preamble manager 1325 is capable of, configured to, or operable to support a means for obtaining a set of multiple random access preambles from a set of multiple user equipment (UEs), where each random access preamble of the set of multiple random access preambles is associated with a respective UE. The path information manager 1330 is capable of, configured to, or operable to support a means for outputting a message indicating path information for the set of multiple random access preambles, where the message further indicates, for each path corresponding to the set of multiple random access preambles, a set of allocated resources including at least a first set of resources, a second set of resources, or an uplink grant, and where the first set of resources corresponds to contention-based random access resources and the second set of resources corresponds to contention-free random access resources. The random access message manager 1335 is capable of, configured to, or operable to support a means for obtaining, from a UE of the set of multiple UEs, a random access message including a first random access preamble using the first set of resources, or the second set of resources, or the uplink grant, where obtaining the random access message using the first set of resources, or the second set of resources, or the uplink grant is based on whether a collision exists for a path associated with a second random access preamble of the set of multiple random access preambles.

In some cases, the random access preamble manager 1325, the path information manager 1330, and the random access message manager 1335 may each be or be at least a part of a processor (e.g., a transceiver processor, or a radio processor, or a transmitter processor, or a receiver processor). The processor may be coupled with at least one memory and execute instructions stored in the memory that enable the processor to perform or facilitate the features of the random access preamble manager 1325, the path information manager 1330, and the random access message manager 1335 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

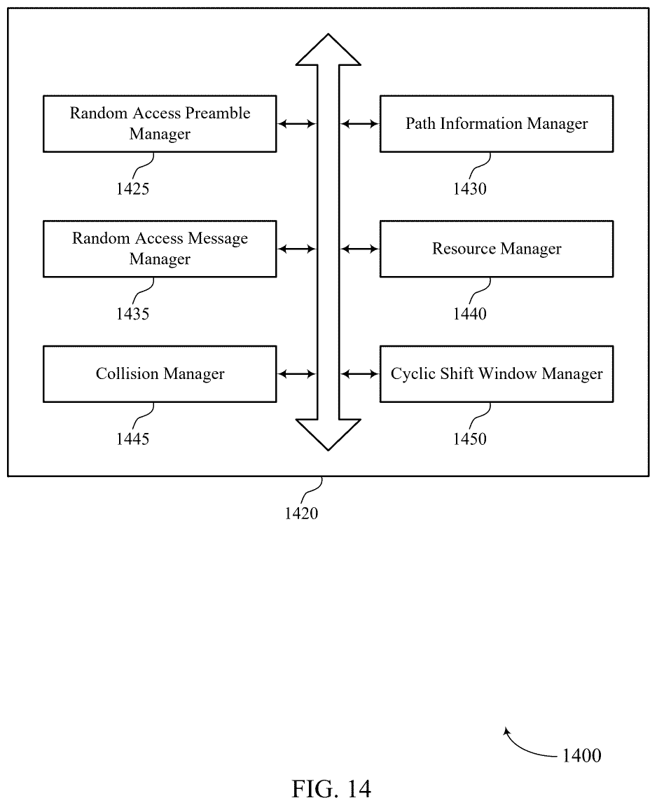

FIG. 14 shows a block diagram 1400 of a communications manager 1420 that supports dedicated preamble allocation for random access messages in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of dedicated preamble allocation for random access messages as described herein. For example, the communications manager 1420 may include a random access preamble manager 1425, a path information manager 1430, a random access message manager 1435, a resource manager 1440, a collision manager 1445, a cyclic shift window manager 1450, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1420 may support wireless communications in accordance with examples as disclosed herein. The random access preamble manager 1425 is capable of, configured to, or operable to support a means for obtaining a set of multiple random access preambles from a set of multiple user equipment (UEs), where each random access preamble of the set of multiple random access preambles is associated with a respective UE. The path information manager 1430 is capable of, configured to, or operable to support a means for outputting a message indicating path information for the set of multiple random access preambles, where the message further indicates, for each path corresponding to the set of multiple random access preambles, a set of allocated resources including at least a first set of resources, a second set of resources, or an uplink grant, and where the first set of resources corresponds to contention-based random access resources and the second set of resources corresponds to contention-free random access resources. The random access message manager 1435 is capable of, configured to, or operable to support a means for obtaining, from a UE of the set of multiple UEs, a random access message including a first random access preamble using the first set of resources, or the second set of resources, or the uplink grant, where obtaining the random access message using the first set of resources, or the second set of resources, or the uplink grant is based on whether a collision exists for a path associated with a second random access preamble of the set of multiple random access preambles.

In some examples, the path information includes a list of cyclic shifts associated with the set of multiple random access preambles, and the resource manager 1440 is capable of, configured to, or operable to support a means for selecting, for each path that corresponds to the list of cyclic shifts, the set of allocated resources based on whether the collision is detected by the network node.

In some examples, the collision manager 1445 is capable of, configured to, or operable to support a means for detecting a possible collision for the path based on the set of multiple random access preambles including the second random access preamble. In some examples, the resource manager 1440 is capable of, configured to, or operable to support a means for allocating the first set of resources or the second set of resources, or both, for the path based at least part on the possible collision, where the random access message is obtained using the second set of resources or the first set of resources in accordance with the message allocating the first set of resources or the second set of resources, or both, for the path.

In some examples, the collision manager 1445 is capable of, configured to, or operable to support a means for detecting an absence of the collision for the path based on the set of multiple random access preambles. In some examples, the resource manager 1440 is capable of, configured to, or operable to support a means for allocating the uplink grant for the path based at least part on the absence of the collision, where the random access message is obtained using the uplink grant in accordance with the message allocating the uplink grant for the path, and where the message further includes an indication of a transmission power control value.

In some examples, the path information includes a set of cyclic shift windows associated with the random access preambles, and the resource manager 1440 is capable of, configured to, or operable to support a means for selecting, for each cyclic shift window of the set of cyclic shift windows, the set of allocated resources based on whether a collision is detected by the network node.

In some examples, a first cyclic shift window of the set of cyclic shift windows is associated with an absence of the collision. In some examples, the message allocates the uplink grant for the first cyclic shift window based on the absence of the collision. In some examples, the message further indicates a transmission power control value and an indication of a detected cyclic shift corresponding to the first cyclic shift window.

In some examples, a second cyclic shift window of the set of cyclic shift windows is associated with a possible collision. In some examples, the message allocates the first set of resources for the second cyclic shift window based on the possible collision. In some examples, the message further indicates a transmission power control value and an indication of one or more detected cyclic shifts corresponding to the second cyclic shift window.

In some examples, a third cyclic shift window of the set of cyclic shift windows is associated with a possible collision. In some examples, the message allocates the second set of resources for the third cyclic shift window based on the possible collision. In some examples, the message further indicates a transmission power control value and an indication of a detected cyclic shift corresponding to the third cyclic shift window.

In some examples, the cyclic shift window manager 1450 is capable of, configured to, or operable to support a means for determining the set of cyclic shift windows based on respective round trip times corresponding to one or more of the set of multiple random access preambles.

In some examples, the random access message manager 1435 is capable of, configured to, or operable to support a means for outputting, based on the random access message, a response message including at least a timing advance, a transmission power control value, and one or more resources for an uplink transmission, or any combination thereof, where the random access message is obtained using the first set of resources.

In some examples, the random access message manager 1435 is capable of, configured to, or operable to support a means for outputting, based on the random access message, a response message including one or more resources for an uplink transmission, where the random access message is obtained using the second set of resources.

In some examples, the first set of resources is associated with one or more parameters that are different from one or more parameters associated with the second set of resources, the one or more parameters including at least a set of candidate cyclic shifts, a set of root sequences, one or more ROs, a cyclic shift step size, or any combination thereof.

In some cases, the random access preamble manager 1425, the path information manager 1430, the random access message manager 1435, the resource manager 1440, the collision manager 1445, and the cyclic shift window manager 1450 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the random access preamble manager 1425, the path information manager 1430, the random access message manager 1435, the resource manager 1440, the collision manager 1445, and the cyclic shift window manager 1450 discussed herein.

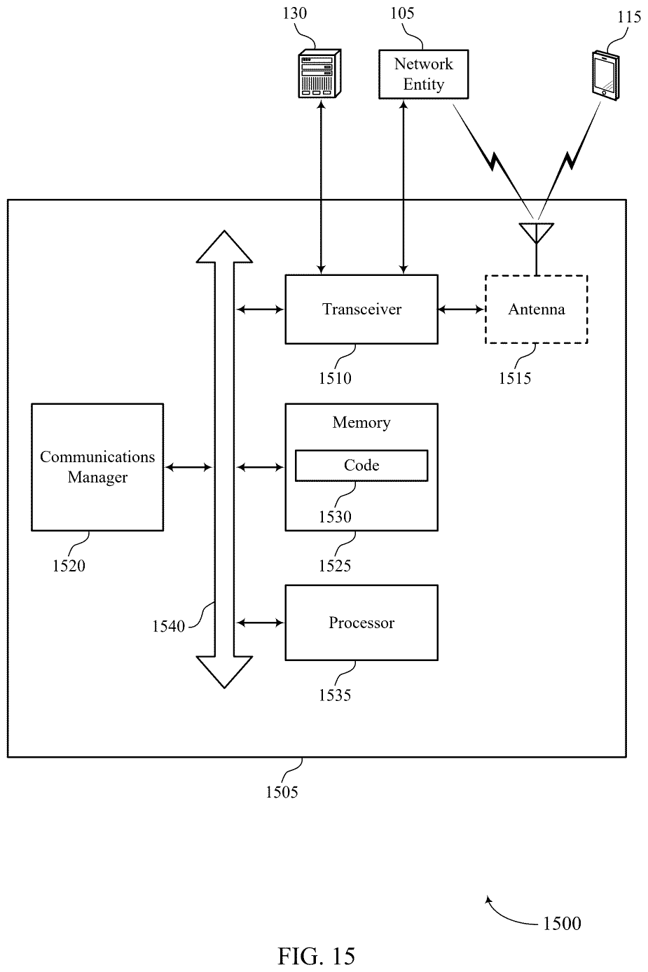

FIG. 15 shows a diagram of a system 1500 including a device 1505 that supports dedicated preamble allocation for random access messages in accordance with one or more aspects of the present disclosure. The device 1505 may be an example of or include components of a device 1205, a device 1305, a network node, or a network entity 105 as described herein. The device 1505 may communicate with other network devices or network equipment such as one or more of the network entities 105, UEs 115, or any combination thereof. The communications may include communications over one or more wired interfaces, over one or more wireless interfaces, or any combination thereof. The device 1505 may include components that support outputting and obtaining communications, such as a communications manager 1520, a transceiver 1510, one or more antennas 1515, at least one memory 1525, code 1530, and at least one processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. In some implementations, the transceiver 1510 may include one or more interfaces, such as one or more interfaces coupled with the one or more antennas 1515 that are configured to support various receiving or obtaining operations, or one or more interfaces coupled with the one or more antennas 1515 that are configured to support various transmitting or outputting operations, or a combination thereof. In some implementations, the transceiver 1510 may include or be configured for coupling with one or more processors or one or more memory components that are operable to perform or support operations based on received or obtained information or signals, or to generate information or other signals for transmission or other outputting, or any combination thereof. In some implementations, the transceiver 1510, or the transceiver 1510 and the one or more antennas 1515, or the transceiver 1510 and the one or more antennas 1515 and one or more processors or one or more memory components (e.g., the at least one processor 1535, the at least one memory 1525, or both), may be included in a chip or chip assembly that is installed in the device 1505. In some examples, the transceiver 1510 may be operable to support communications via one or more communications links (e.g., communication link(s) 125, backhaul communication link(s) 120, a midhaul communication link 162, a fronthaul communication link 168).

The at least one memory 1525 may include RAM, ROM, or any combination thereof. The at least one memory 1525 may store computer-readable, computer-executable, or processor-executable code, such as the code 1530. The code 1530 may include instructions that, when executed by one or more of the at least one processor 1535, cause the device 1505 to perform various functions described herein. The code 1530 may be stored in a non-transitory computer-readable medium such as system memory or another type of memory. In some cases, the code 1530 may not be directly executable by a processor of the at least one processor 1535 but may cause a computer (e.g., when compiled and executed) to perform functions described herein. In some cases, the at least one memory 1525 may include, among other things, a BIOS which may control basic hardware or software operation such as the interaction with peripheral components or devices. In some examples, the at least one processor 1535 may include multiple processors and the at least one memory 1525 may include multiple memories. One or more of the multiple processors may be coupled with one or more of the multiple memories which may, individually or collectively, be configured to perform various functions herein (for example, as part of a processing system).

The at least one processor 1535 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1535 may be configured to operate a memory array using a memory controller. In some other cases, a memory controller may be integrated into one or more of the at least one processor 1535. The at least one processor 1535 may be configured to execute computer-readable instructions stored in a memory (e.g., one or more of the at least one memory 1525) to cause the device 1505 to perform various functions (e.g., functions or tasks supporting dedicated preamble allocation for random access messages). For example, the device 1505 or a component of the device 1505 may include at least one processor 1535 and at least one memory 1525 coupled with one or more of the at least one processor 1535, the at least one processor 1535 and the at least one memory 1525 configured to perform various functions described herein. The at least one processor 1535 may be an example of a cloud-computing platform (e.g., one or more physical nodes and supporting software such as operating systems, virtual machines, or container instances) that may host the functions (e.g., by executing code 1530) to perform the functions of the device 1505. The at least one processor 1535 may be any one or more suitable processors capable of executing scripts or instructions of one or more software programs stored in the device 1505 (such as within one or more of the at least one memory 1525).

In some examples, the at least one processor 1535 may include multiple processors and the at least one memory 1525 may include multiple memories. One or more of the multiple processors may be coupled with one or more of the multiple memories, which may, individually or collectively, be configured to perform various functions herein. In some examples, the at least one processor 1535 may be a component of a processing system, which may refer to a system (such as a series) of machines, circuitry (including, for example, one or both of processor circuitry (which may include the at least one processor 1535) and memory circuitry (which may include the at least one memory 1525)), or components, that receives or obtains inputs and processes the inputs to produce, generate, or obtain a set of outputs. The processing system may be configured to perform one or more of the functions described herein. For example, the at least one processor 1535 or a processing system including the at least one processor 1535 may be configured to, configurable to, or operable to cause the device 1505 to perform one or more of the functions described herein. Further, as described herein, being “configured to,” being “configurable to,” and being “operable to” may be used interchangeably and may be associated with a capability, when executing code stored in the at least one memory 1525 or otherwise, to perform one or more of the functions described herein.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the at least one memory 1525, the code 1530, and the at least one processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with one or more other network entities 105, and may include a controller or scheduler for controlling communications with UEs 115 (e.g., in cooperation with the one or more other network devices). In some examples, the communications manager 1520 may support an X2 interface within an LTE/LTE-A wireless communications network technology to provide communication between network entities 105.

The communications manager 1520 may support wireless communications in accordance with examples as disclosed herein. For example, the communications manager 1520 is capable of, configured to, or operable to support a means for obtaining a set of multiple random access preambles from a set of multiple user equipment (UEs), where each random access preamble of the set of multiple random access preambles is associated with a respective UE. The communications manager 1520 is capable of, configured to, or operable to support a means for outputting a message indicating path information for the set of multiple random access preambles, where the message further indicates, for each path corresponding to the set of multiple random access preambles, a set of allocated resources including at least a first set of resources, a second set of resources, or an uplink grant, and where the first set of resources corresponds to contention-based random access resources and the second set of resources corresponds to contention-free random access resources. The communications manager 1520 is capable of, configured to, or operable to support a means for obtaining, from a UE of the set of multiple UEs, a random access message including a first random access preamble using the first set of resources, or the second set of resources, or the uplink grant, where obtaining the random access message using the first set of resources, or the second set of resources, or the uplink grant is based on whether a collision exists for a path associated with a second random access preamble of the set of multiple random access preambles.

By including or configuring the communications manager 1520 in accordance with examples as described herein, the device 1505 may support techniques for improved communication reliability, reduced latency, reduced processing, reduced power consumption, more efficient utilization of communication resources, improved coordination between devices, among other examples. In some cases, resources selected by another device (e.g., a UE) may inform the device 1505 whether a collision exists for a random access preamble transmission, which may enable faster contention resolution for random access procedures, thereby enabling the other device to more efficiently establish a connection with a network.

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the transceiver 1510, one or more of the at least one processor 1535, one or more of the at least one memory 1525, the code 1530, or any combination thereof (for example, by a processing system including at least a portion of the at least one processor 1535, the at least one memory 1525, the code 1530, or any combination thereof). For example, the code 1530 may include instructions executable by one or more of the at least one processor 1535 to cause the device 1505 to perform various aspects of dedicated preamble allocation for random access messages as described herein, or the at least one processor 1535 and the at least one memory 1525 may be otherwise configured to, individually or collectively, perform or support such operations.

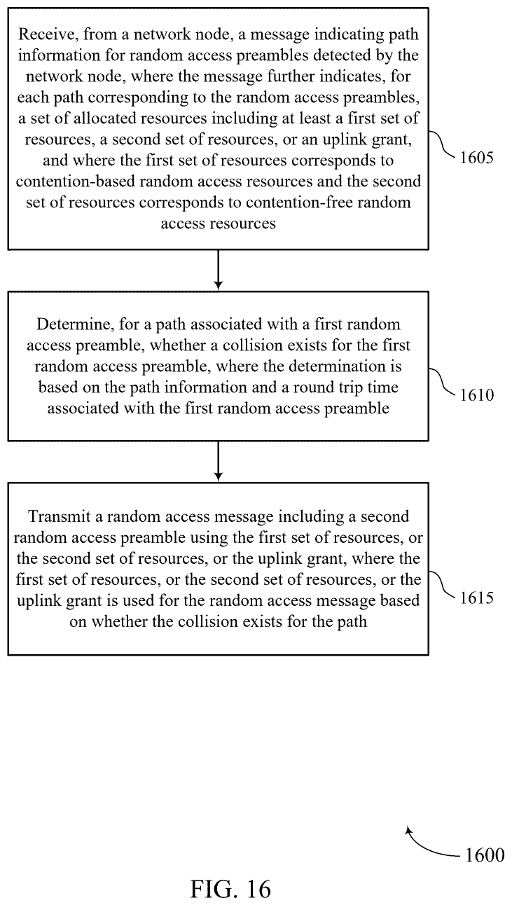

FIG. 16 shows a flowchart illustrating a method 1600 that supports dedicated preamble allocation for random access messages in accordance with one or more aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1605, the method may include receiving, from a network node, a message indicating path information for random access preambles detected by the network node, where the message further indicates, for each path corresponding to the random access preambles, a set of allocated resources including at least a first set of resources, a second set of resources, or an uplink grant, and where the first set of resources corresponds to contention-based random access resources and the second set of resources corresponds to contention-free random access resources. The operations of 1605 may be performed in accordance with examples as disclosed herein. In some examples, aspects of the operations of 1605 may be performed by a path information component 1025 as described with reference to FIG. 10.

At 1610, the method may include determining, for a path associated with a first random access preamble transmitted by the UE, whether a collision exists for the first random access preamble, where the determination is based on the path information and a round trip time associated with the first random access preamble. The operations of 1610 may be performed in accordance with examples as disclosed herein. In some examples, aspects of the operations of 1610 may be performed by a collision component 1030 as described with reference to FIG. 10.

At 1615, the method may include transmitting a random access message including a second random access preamble using the first set of resources, or the second set of resources, or the uplink grant, where the first set of resources, or the second set of resources, or the uplink grant is used for the random access message based on whether the collision exists for the path. The operations of 1615 may be performed in accordance with examples as disclosed herein. In some examples, aspects of the operations of 1615 may be performed by a random access component 1035 as described with reference to FIG. 10.

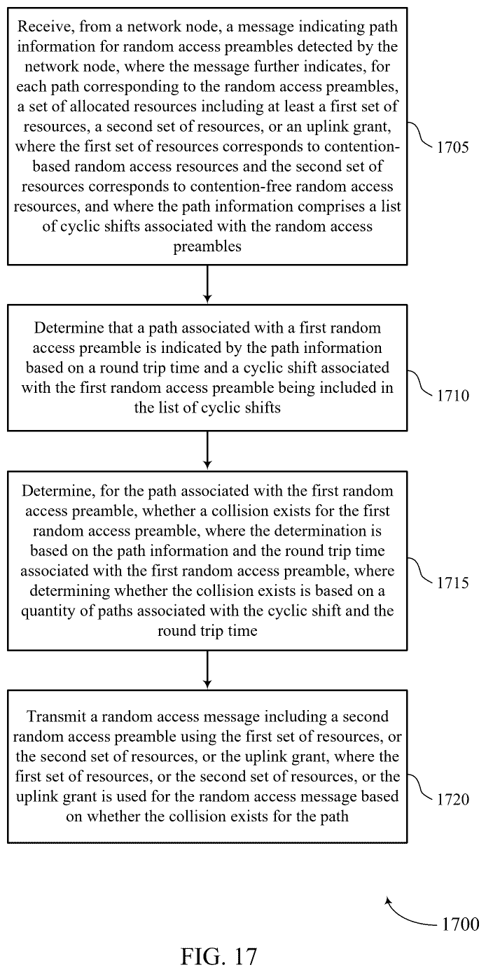

FIG. 17 shows a flowchart illustrating a method 1700 that supports dedicated preamble allocation for random access messages in accordance with one or more aspects of the present disclosure. The operations of the method 1700 may be implemented by a UE or its components as described herein. For example, the operations of the method 1700 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1705, the method may include receiving, from a network node, a message indicating path information for random access preambles detected by the network node, where the message further indicates, for each path corresponding to the random access preambles, a set of allocated resources including at least a first set of resources, a second set of resources, or an uplink grant, where the first set of resources corresponds to contention-based random access resources and the second set of resources corresponds to contention-free random access resources, and where the path information comprises a list of cyclic shifts associated with the random access preambles. The operations of 1705 may be performed in accordance with examples as disclosed herein. In some examples, aspects of the operations of 1705 may be performed by a path information component 1025 as described with reference to FIG. 10.

At 1710, the method may include determining that a path associated with a first random access preamble is indicated by the path information based on a round trip time and a cyclic shift associated with the first random access preamble included in the list of cyclic shifts. The operations of 1710 may be performed in accordance with examples as disclosed herein. In some examples, aspects of the operations of 1710 may be performed by a path information component 1025 as described with reference to FIG. 10.

At 1715, the method may include determining, for a path associated with a first random access preamble, whether a collision exists for the first random access preamble, where the determination is based on the path information and a round trip time associated with the first random access preamble, where determining whether the collision exists is based on a quantity of paths associated with the cyclic shift and the round trip time. The operations of 1715 may be performed in accordance with examples as disclosed herein. In some examples, aspects of the operations of 1715 may be performed by a collision component 1030 as described with reference to FIG. 10.

At 1720, the method may include transmitting a random access message including a second random access preamble using the first set of resources, or the second set of resources, or the uplink grant, where the first set of resources, or the second set of resources, or the uplink grant is used for the random access message based on whether the collision exists for the path. The operations of 1720 may be performed in accordance with examples as disclosed herein. In some examples, aspects of the operations of 1720 may be performed by a random access component 1035 as described with reference to FIG. 10.

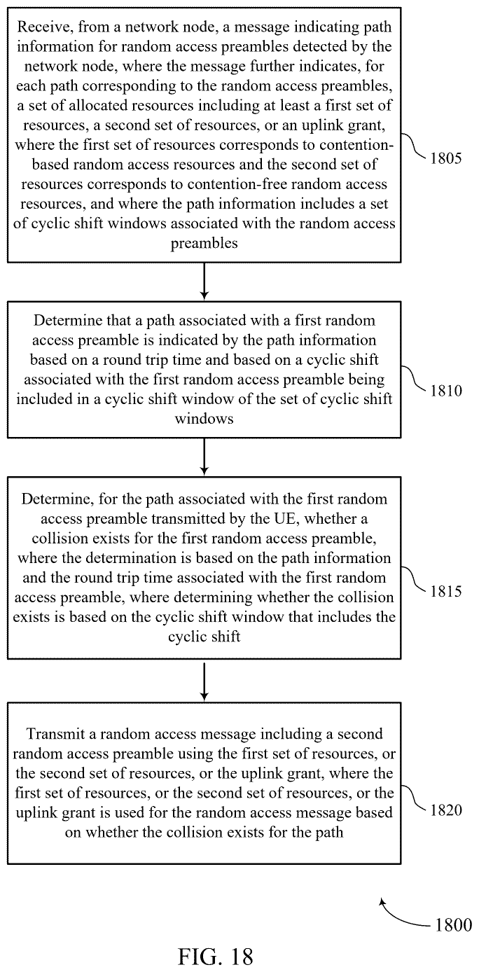

FIG. 18 shows a flowchart illustrating a method 1800 that supports dedicated preamble allocation for random access messages in accordance with one or more aspects of the present disclosure. The operations of the method 1800 may be implemented by a UE or its components as described herein. For example, the operations of the method 1800 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1805, the method may include receiving, from a network node, a message indicating path information for random access preambles detected by the network node, where the message further indicates, for each path corresponding to the random access preambles, a set of allocated resources including at least a first set of resources, a second set of resources, or an uplink grant, where the first set of resources corresponds to contention-based random access resources and the second set of resources corresponds to contention-free random access resources, and where the path information includes a set of cyclic shift windows associated with the random access preambles. The operations of 1805 may be performed in accordance with examples as disclosed herein. In some examples, aspects of the operations of 1805 may be performed by a path information component 1025 as described with reference to FIG. 10.

At 1810, the method may include determining that a path associated with a first random access preamble is indicated by the path information based on a round trip time and based on a cyclic shift associated with the first random access preamble being included in a cyclic shift window of the set of cyclic shift windows. The operations of 1810 may be performed in accordance with examples as disclosed herein. In some examples, aspects of the operations of 1810 may be performed by a path information component 1025 as described with reference to FIG. 10.

At 1815, the method may include determining, for a path associated with a first random access preamble, whether a collision exists for the first random access preamble, where the determination is based on the path information and a round trip time associated with the first random access preamble, where determining whether the collision exists is based on the cyclic shift window that includes the cyclic shift. The operations of 1815 may be performed in accordance with examples as disclosed herein. In some examples, aspects of the operations of 1815 may be performed by a collision component 1030 as described with reference to FIG. 10.

At 1820, the method may include transmitting a random access message including a second random access preamble using the first set of resources, or the second set of resources, or the uplink grant, where the first set of resources, or the second set of resources, or the uplink grant is used for the random access message based on whether the collision exists for the path. The operations of 1820 may be performed in accordance with examples as disclosed herein. In some examples, aspects of the operations of 1820 may be performed by a random access component 1035 as described with reference to FIG. 10.

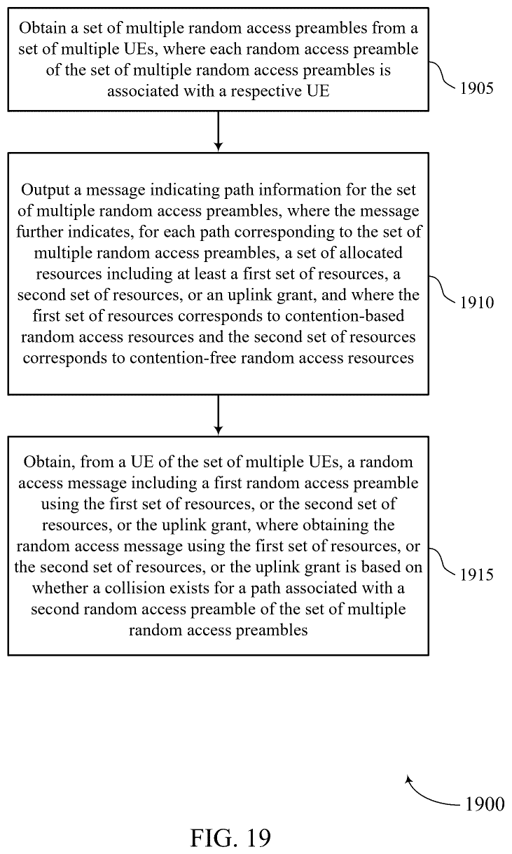

FIG. 19 shows a flowchart illustrating a method 1900 that supports dedicated preamble allocation for random access messages in accordance with one or more aspects of the present disclosure. The operations of the method 1900 may be implemented by a network entity or its components as described herein. For example, the operations of the method 1900 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 1905, the method may include obtaining a set of multiple random access preambles from a set of multiple UEs, where each random access preamble of the set of multiple random access preambles is associated with a respective UE. The operations of 1905 may be performed in accordance with examples as disclosed herein. In some examples, aspects of the operations of 1905 may be performed by a random access preamble manager 1425 as described with reference to FIG. 14.

At 1910, the method may include outputting a message indicating path information for the set of multiple random access preambles, where the message further indicates, for each path corresponding to the set of multiple random access preambles, a set of allocated resources including at least a first set of resources, a second set of resources, or an uplink grant, and where the first set of resources corresponds to contention-based random access resources and the second set of resources corresponds to contention-free random access resources. The operations of 1910 may be performed in accordance with examples as disclosed herein. In some examples, aspects of the operations of 1910 may be performed by a path information manager 1430 as described with reference to FIG. 14.

At 1915, the method may include obtaining, from a UE of the set of multiple UEs, a random access message including a first random access preamble using the first set of resources, or the second set of resources, or the uplink grant, where obtaining the random access message using the first set of resources, or the second set of resources, or the uplink grant is based on whether a collision exists for a path associated with a second random access preamble of the set of multiple random access preambles. The operations of 1915 may be performed in accordance with examples as disclosed herein. In some examples, aspects of the operations of 1915 may be performed by a random access message manager 1435 as described with reference to FIG. 14.

The following provides an overview of aspects of the present disclosure:

Aspect 1: A method for wireless communications at a UE, comprising: receiving, from a network node, a message indicating path information for random access preambles detected by the network node, wherein the message further indicates, for each path corresponding to the random access preambles, a set of allocated resources including at least a first set of resources, a second set of resources, or an uplink grant, and wherein the first set of resources corresponds to contention-based random access resources and the second set of resources corresponds to contention-free random access resources; determining, for a path associated with a first random access preamble transmitted by the UE, whether a collision exists for the first random access preamble, wherein the determination is based at least in part on the path information and a round trip time associated with the first random access preamble; and transmitting a random access message comprising a second random access preamble using the first set of resources, or the second set of resources, or the uplink grant, wherein the first set of resources, or the second set of resources, or the uplink grant is used for the random access message based at least in part on whether the collision exists for the path.

Aspect 2: The method of aspect 1, wherein the path information comprises a list of cyclic shifts associated with the random access preambles, the method further comprising: determining that the path associated with the first random access preamble is indicated by the path information based at least in part on the round trip time and a cyclic shift associated with the first random access preamble included in the list of cyclic shifts, wherein determining whether the collision exists is based at least in part on a quantity of paths associated with the cyclic shift and the round trip time.

Aspect 3: The method of aspect 2, wherein determining whether the collision exists for the first random access preamble comprises: determining an absence of the collision for the first random access preamble based at least in part on a single path being associated with the cyclic shift and the round trip time, wherein the random access message is transmitted using the uplink grant based at least in part on the single path being associated with the cyclic shift and the round trip time and in accordance with the message allocating the uplink grant for the single path.

Aspect 4: The method of aspect 2, wherein determining whether the collision exists for the first random access preamble comprises: determining an absence of the collision for the first random access preamble based at least in part on a single path being associated with the cyclic shift and the round trip time, wherein the random access message is transmitted using the second set of resources based at least in part on the single path being associated with the cyclic shift and the round trip time and in accordance with the message allocating the second set of resources for the single path.

Aspect 5: The method of aspect 2, wherein determining whether the collision exists for the first random access preamble comprises: determining that the collision exists for the first random access preamble based at least in part on multiple paths being associated with the cyclic shift and the round trip time, wherein the random access message is transmitted using the first set of resources based at least in part on the multiple paths being associated with the cyclic shift and the round trip time and in accordance with the message indicating that the first set of resources is allocated for at least one of the multiple paths.

Aspect 6: The method of aspect 2, further comprising: retransmitting a first random access message based at least in part on the cyclic shift being excluded from the list of cyclic shifts.

Aspect 7: The method of any of aspects 2 through 6, wherein the cyclic shift is adjusted by the UE based at least in part on a cyclic shift offset, and determining whether the collision exists is based at least in part on cyclic shift and the cyclic shift offset.

Aspect 8: The method of aspect 1, wherein the path information comprises a set of cyclic shift windows associated with the random access preambles, the method further comprising: determining that the path associated with the first random access preamble is indicated by the path information based at least in part on the round trip time and based at least in part on a cyclic shift associated with the first random access preamble being included in a cyclic shift window of the set of cyclic shift windows, wherein determining whether the collision exists is based at least in part on the cyclic shift window that includes the cyclic shift.

Aspect 9: The method of aspect 8, wherein determining whether the collision exists for the first random access preamble comprises: determining an absence of the collision for the first random access preamble based at least in part on the cyclic shift window being associated with an absence of collisions, wherein the random access message is transmitted using the uplink grant in accordance with the message allocating the uplink grant for the cyclic shift window.

Aspect 10: The method of aspect 8, wherein determining whether the collision exists for the first random access preamble comprises: determining an absence of the collision for the first random access preamble based at least in part on the cyclic shift window being associated with an absence of collisions, wherein the random access message is transmitted using the second set of resources in accordance with the message allocating the second set of resources for the cyclic shift window.

Aspect 11: The method of aspect 8, wherein determining whether the collision exists for the first random access preamble comprises: determining that the collision exists for the first random access preamble based at least in part on the cyclic shift window being associated with one or more collisions, wherein the random access message is transmitted using the first set of resources in accordance with the message allocating the first set of resources for the cyclic shift window.

Aspect 12: The method of any of aspects 1 through 11, further comprising: retransmitting a first random access message based at least in part on the path information excluding one or more paths associated with the first random access preamble, the round trip time associated with the first random access preamble, or both.

Aspect 13: The method of any of aspects 1 through 12, further comprising: selecting a transmission power control value for transmitting the random access message based at least in part on the path associated with the first random access preamble, wherein the random access message is transmitted using the second set of resources.

Aspect 14: The method of any of aspects 1 through 13, further comprising: computing a timing advance value for transmitting the random access message based at least in part on a difference between a cyclic shift indicated by the path information and a first cyclic shift associated with the first random access preamble, the first cyclic shift having a cyclic shift offset applied, wherein the random access message is transmitted using the second set of resources.

Aspect 15: The method of aspect 14, further comprising: applying the timing advance value to the random access message in a time domain, wherein a cyclic shift corresponding to the second random access preamble corresponds to an allocated cyclic shift of the second set of resources.

Aspect 16: The method of aspect 14, further comprising: applying the timing advance value to the random access message in a cyclic shift domain, wherein a cyclic shift corresponding to the second random access preamble is based at least in part on a difference between the timing advance value and an allocated cyclic shift of the second set of resources.

Aspect 17: The method of any of aspects 1 through 16, wherein the random access message is transmitted using a first timing advance and a first transmission power control value that respectively correspond to a second timing advance and a second transmission power control value used for transmitting the first random access preamble, the random access message is transmitted using the first set of resources.

Aspect 18: The method of any of aspects 1 through 17, further comprising: receiving, from the network node and based at least in part on the random access message, a response message comprising at least a timing advance, a transmission power control value, and one or more resources for an uplink transmission, or any combination thereof, wherein the random access message is transmitted using the first set of resources.

Aspect 19: The method of any of aspects 1 through 18, further comprising: receiving, from the network node and based at least in part on the random access message, a response message comprising one or more resources for an uplink transmission, wherein the random access message is transmitted using the second set of resources.

Aspect 20: The method of any of aspects 1 through 19, wherein the first set of resources is associated with one or more parameters that are different from one or more parameters associated with the second set of resources, the one or more parameters comprising at least a set of candidate cyclic shifts, a set of root sequences, one or more random access occasions, a cyclic shift step size, or any combination thereof.

Aspect 21: A method for wireless communications at a network node, comprising: obtaining a plurality of random access preambles from a plurality of user equipment (UEs), wherein each random access preamble of the plurality of random access preambles is associated with a respective UE; outputting a message indicating path information for the plurality of random access preambles, wherein the message further indicates, for each path corresponding to the plurality of random access preambles, a set of allocated resources including at least a first set of resources, a second set of resources, or an uplink grant, and wherein the first set of resources corresponds to contention-based random access resources and the second set of resources corresponds to contention-free random access resources; and obtaining, from a UE of the plurality of UEs, a random access message comprising a first random access preamble using the first set of resources, or the second set of resources, or the uplink grant, wherein obtaining the random access message using the first set of resources, or the second set of resources, or the uplink grant is based at least in part on whether a collision exists for a path associated with a second random access preamble of the plurality of random access preambles.

Aspect 22: The method of aspect 21, wherein the path information comprises a list of cyclic shifts associated with the plurality of random access preambles, the method further comprising: selecting, for each path that corresponds to the list of cyclic shifts, the set of allocated resources based at least in part on whether the collision is detected by the network node.

Aspect 23: The method of aspect 22, further comprising: detecting a possible collision for the path based at least in part on the plurality of random access preambles including the second random access preamble; and allocating the first set of resources or the second set of resources, or both, for the path based at least part on the possible collision, wherein the random access message is obtained using the second set of resources or the first set of resources in accordance with the message allocating the first set of resources or the second set of resources, or both, for the path.

Aspect 24: The method of any of aspects 22 through 23, further comprising: detecting an absence of the collision for the path based at least in part on the plurality of random access preambles; and allocating the uplink grant for the path based at least part on the absence of the collision, wherein the random access message is obtained using the uplink grant in accordance with the message allocating the uplink grant for the path, and wherein the message further comprises an indication of a transmission power control value.

Aspect 25: The method of any of aspects 21 through 24, wherein the path information comprises a set of cyclic shift windows associated with the random access preambles, the method further comprising: selecting, for each cyclic shift window of the set of cyclic shift windows, the set of allocated resources based at least in part on whether a collision is detected by the network node.

Aspect 26: The method of aspect 25, wherein a first cyclic shift window of the set of cyclic shift windows is associated with an absence of the collision, the message allocates the uplink grant for the first cyclic shift window based at least in part on the absence of the collision, and the message further indicates a transmission power control value and an indication of a detected cyclic shift corresponding to the first cyclic shift window.

Aspect 27: The method of any of aspects 25 through 26, wherein a second cyclic shift window of the set of cyclic shift windows is associated with a possible collision, the message allocates the first set of resources for the second cyclic shift window based at least in part on the possible collision, and the message further indicates a transmission power control value and an indication of one or more detected cyclic shifts corresponding to the second cyclic shift window.

Aspect 28: The method of any of aspects 25 through 27, wherein a third cyclic shift window of the set of cyclic shift windows is associated with a possible collision, the message allocates the second set of resources for the third cyclic shift window based at least in part on the possible collision, and the message further indicates a transmission power control value and an indication of a detected cyclic shift corresponding to the third cyclic shift window.

Aspect 29: The method of any of aspects 25 through 28, further comprising: determining the set of cyclic shift windows based at least in part on respective round trip times corresponding to one or more of the plurality of random access preambles.

Aspect 30: The method of any of aspects 21 through 29, further comprising: outputting, based at least in part on the random access message, a response message comprising at least a timing advance, a transmission power control value, and one or more resources for an uplink transmission, or any combination thereof, wherein the random access message is obtained using the first set of resources.

Aspect 31: The method of any of aspects 21 through 30, further comprising: outputting, based at least in part on the random access message, a response message comprising one or more resources for an uplink transmission, wherein the random access message is obtained using the second set of resources.

Aspect 32: The method of any of aspects 21 through 31, wherein the first set of resources is associated with one or more parameters that are different from one or more parameters associated with the second set of resources, the one or more parameters comprising at least a set of candidate cyclic shifts, a set of root sequences, one or more random access occasions, a cyclic shift step size, or any combination thereof.

Aspect 33: A UE for wireless communications, comprising one or more memories storing processor-executable code, and one or more processors coupled with the one or more memories and individually or collectively configured to cause the UE to perform a method of any of aspects 1 through 20.

Aspect 34: A UE for wireless communications, comprising at least one means for performing a method of any of aspects 1 through 20.

Aspect 35: A non-transitory computer-readable medium storing code for wireless communications, the code comprising instructions executable by one or more processors to perform a method of any of aspects 1 through 20.

Aspect 36: A network node for wireless communications, comprising one or more memories storing processor-executable code, and one or more processors coupled with the one or more memories and individually or collectively configured to cause the network node to perform a method of any of aspects 21 through 32.

Aspect 37: A network node for wireless communications, comprising at least one means for performing a method of any of aspects 21 through 32.

Aspect 38: A non-transitory computer-readable medium storing code for wireless communications, the code comprising instructions executable by one or more processors to perform a method of any of aspects 21 through 32.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories, wherein the one or more processors are individually or collectively configured to cause the UE to:
receive, from a network node, a message indicating path information for random access preambles detected by the network node, wherein the message further indicates, for each path corresponding to the random access preambles, a set of allocated resources including at least a first set of resources, a second set of resources, or an uplink grant, and wherein the first set of resources corresponds to contention-based random access resources and the second set of resources corresponds to contention-free random access resources;
determine, for a path associated with a first random access preamble transmitted by the UE, whether a collision exists for the first random access preamble, wherein the determination is based at least in part on the path information and a round trip time associated with the first random access preamble; and
transmit a random access message comprising a second random access preamble using the first set of resources, or the second set of resources, or the uplink grant, wherein the first set of resources, or the second set of resources, or the uplink grant is used for the random access message based at least in part on whether the collision exists for the path.

2. The UE of claim 1, wherein the path information comprises a list of cyclic shifts associated with the random access preambles, and the one or more processors are individually or collectively further configured to cause the UE to:
determine that the path associated with the first random access preamble is indicated by the path information based at least in part on the round trip time and a cyclic shift associated with the first random access preamble included in the list of cyclic shifts, wherein determining whether the collision exists is based at least in part on a quantity of paths associated with the cyclic shift and the round trip time.

3. The UE of claim 2, wherein the one or more processors are individually or collectively configured to cause the UE to determine whether the collision exists for the first random access preamble by being individually or collectively further configured to cause the UE to:
determine an absence of the collision for the first random access preamble based at least in part on a single path being associated with the cyclic shift and the round trip time, wherein the random access message is transmitted using the uplink grant based at least in part on the single path being associated with the cyclic shift and the round trip time and in accordance with the message allocating the uplink grant for the single path.

4. The UE of claim 2, wherein the one or more processors are individually or collectively configured to cause the UE to determine whether the collision exists for the first random access preamble by being individually or collectively configured to cause the UE to:
determine an absence of the collision for the first random access preamble based at least in part on a single path being associated with the cyclic shift and the round trip time, wherein the random access message is transmitted using the second set of resources based at least in part on the single path being associated with the cyclic shift and the round trip time and in accordance with the message allocating the second set of resources for the single path.

5. The UE of claim 2, wherein the one or more processors are individually or collectively configured to cause the UE to determine whether the collision exists for the first random access preamble by being individually or collectively configured to cause the UE to:
determine that the collision exists for the first random access preamble based at least in part on multiple paths being associated with the cyclic shift and the round trip time, wherein the random access message is transmitted using the first set of resources based at least in part on the multiple paths being associated with the cyclic shift and the round trip time and in accordance with the message indicating that the first set of resources is allocated for at least one of the multiple paths.

6. The UE of claim 2, wherein the one or more processors are individually or collectively further configured to cause the UE to:
retransmit a first random access message based at least in part on the cyclic shift being excluded from the list of cyclic shifts.

7. The UE of claim 2, wherein the cyclic shift is adjusted by the UE based at least in part on a cyclic shift offset, and wherein determining whether the collision exists is based at least in part on cyclic shift and the cyclic shift offset.

8. The UE of claim 1, wherein the path information comprises a set of cyclic shift windows associated with the random access preambles, and the one or more processors are individually or collectively further configured to cause the UE to:
determine that the path associated with the first random access preamble is indicated by the path information based at least in part on the round trip time and based at least in part on a cyclic shift associated with the first random access preamble being included in a cyclic shift window of the set of cyclic shift windows, wherein determining whether the collision exists is based at least in part on the cyclic shift window that includes the cyclic shift.

9. The UE of claim 8, wherein the one or more processors are individually or collectively configured to cause the UE to determine whether the collision exists for the first random access preamble by being individually or collectively configured to cause the UE to:
determine an absence of the collision for the first random access preamble based at least in part on the cyclic shift window being associated with an absence of collisions, wherein the random access message is transmitted using the uplink grant in accordance with the message allocating the uplink grant for the cyclic shift window.

10. The UE of claim 8, wherein the one or more processors are individually or collectively configured to cause the UE to determine whether the collision exists for the first random access preamble by being individually or collectively configured to cause the UE to:
determine an absence of the collision for the first random access preamble based at least in part on the cyclic shift window being associated with an absence of collisions, wherein the random access message is transmitted using the second set of resources in accordance with the message allocating the second set of resources for the cyclic shift window.

11. The UE of claim 8, wherein the one or more processors are individually or collectively configured to cause the UE to determine whether the collision exists for the first random access preamble by being individually or collectively configured to cause the UE to:
determine that the collision exists for the first random access preamble based at least in part on the cyclic shift window being associated with one or more collisions, wherein the random access message is transmitted using the first set of resources in accordance with the message allocating the first set of resources for the cyclic shift window.

12. The UE of claim 1, wherein the one or more processors are individually or collectively further configured to cause the UE to:
retransmit a first random access message based at least in part on the path information excluding one or more paths associated with the first random access preamble, the round trip time associated with the first random access preamble, or both.

13. The UE of claim 1, wherein the one or more processors are individually or collectively further configured to cause the UE to:
select a transmission power control value for transmitting the random access message based at least in part on the path associated with the first random access preamble, wherein the random access message is transmitted using the second set of resources.

14. The UE of claim 1, wherein the one or more processors are individually or collectively further configured to cause the UE to:
compute a timing advance value for transmitting the random access message based at least in part on a difference between a cyclic shift indicated by the path information and a first cyclic shift associated with the first random access preamble, the first cyclic shift having a cyclic shift offset applied, wherein the random access message is transmitted using the second set of resources.

15. The UE of claim 14, wherein the one or more processors are individually or collectively further configured to cause the UE to:
apply the timing advance value to the random access message in a time domain, wherein a cyclic shift corresponding to the second random access preamble corresponds to an allocated cyclic shift of the second set of resources.

16. The UE of claim 14, wherein the one or more processors are individually or collectively further configured to cause the UE to:
apply the timing advance value to the random access message in a cyclic shift domain, wherein a cyclic shift corresponding to the second random access preamble is based at least in part on a difference between the timing advance value and an allocated cyclic shift of the second set of resources.

17. The UE of claim 1, wherein the random access message is transmitted using a first timing advance and a first transmission power control value that respectively correspond to a second timing advance and a second transmission power control value used for transmitting the first random access preamble, and wherein the random access message is transmitted using the first set of resources.

18. The UE of claim 1, wherein the one or more processors are individually or collectively further configured to cause the UE to:
receive, from the network node and based at least in part on the random access message, a response message comprising at least a timing advance, a transmission power control value, and one or more resources for an uplink transmission, or any combination thereof, wherein the random access message is transmitted using the first set of resources.

19. The UE of claim 1, wherein the one or more processors are individually or collectively further configured to cause the UE to:
receive, from the network node and based at least in part on the random access message, a response message comprising one or more resources for an uplink transmission, wherein the random access message is transmitted using the second set of resources.

20. The UE of claim 1, wherein the first set of resources is associated with one or more parameters that are different from one or more parameters associated with the second set of resources, the one or more parameters comprising at least a set of candidate cyclic shifts, a set of root sequences, one or more random access occasions, a cyclic shift step size, or any combination thereof.

21. A network node, comprising:
one or more memories storing processor-executable code; and
one or more processors coupled with the one or more memories, wherein the one or more processors are individually or collectively configured to cause the network node to:
obtain a plurality of random access preambles from a plurality of user equipment (UEs), wherein each random access preamble of the plurality of random access preambles is associated with a respective UE;
output a message indicating path information for the plurality of random access preambles, wherein the message further indicates, for each path corresponding to the plurality of random access preambles, a set of allocated resources including at least a first set of resources, a second set of resources, or an uplink grant, and wherein the first set of resources corresponds to contention-based random access resources and the second set of resources corresponds to contention-free random access resources; and
obtain, from a UE of the plurality of UEs, a random access message comprising a first random access preamble using the first set of resources, or the second set of resources, or the uplink grant, wherein obtaining the random access message using the first set of resources, or the second set of resources, or the uplink grant is based at least in part on whether a collision exists for a path associated with a second random access preamble of the plurality of random access preambles.

22. The network node of claim 21, wherein the path information comprises a list of cyclic shifts associated with the plurality of random access preambles, and the one or more processors are individually or collectively further configured to cause the network node to:
select, for each path that corresponds to the list of cyclic shifts, the set of allocated resources based at least in part on whether the collision is detected by the network node.

23. The network node of claim 22, wherein the one or more processors are individually or collectively further configured to cause the network node to:
detect a possible collision for the path based at least in part on the plurality of random access preambles including the second random access preamble; and
allocate the first set of resources or the second set of resources, or both, for the path based at least part on the possible collision, wherein the random access message is obtained using the second set of resources or the first set of resources in accordance with the message allocating the first set of resources or the second set of resources, or both, for the path.

24. The network node of claim 22, wherein the one or more processors are individually or collectively further configured to cause the network node to:
detect an absence of the collision for the path based at least in part on the plurality of random access preambles; and
allocate the uplink grant for the path based at least part on the absence of the collision, wherein the random access message is obtained using the uplink grant in accordance with the message allocating the uplink grant for the path, and wherein the message further comprises an indication of a transmission power control value.

25. The network node of claim 21, wherein the path information comprises a set of cyclic shift windows associated with the plurality of random access preambles, and the one or more processors are individually or collectively further operable to execute the code to cause the network node to:
select, for each cyclic shift window of the set of cyclic shift windows, the set of allocated resources based at least in part on whether a collision is detected by the network node.

26. The network node of claim 25, wherein a first cyclic shift window of the set of cyclic shift windows is associated with an absence of the collision, wherein the message allocates the uplink grant for the first cyclic shift window based at least in part on the absence of the collision, and wherein the message further indicates a transmission power control value and an indication of a detected cyclic shift corresponding to the first cyclic shift window.

27. The network node of claim 25, wherein a second cyclic shift window of the set of cyclic shift windows is associated with a possible collision, wherein the message allocates the first set of resources for the second cyclic shift window based at least in part on the possible collision, and wherein the message further indicates a transmission power control value and an indication of one or more detected cyclic shifts corresponding to the second cyclic shift window.

28. The network node of claim 25, wherein a third cyclic shift window of the set of cyclic shift windows is associated with a possible collision, wherein the message allocates the second set of resources for the third cyclic shift window based at least in part on the possible collision, and wherein the message further indicates a transmission power control value and an indication of a detected cyclic shift corresponding to the third cyclic shift window.

29. A method for wireless communications at a user equipment (UE), comprising:
receiving, from a network node, a message indicating path information for random access preambles detected by the network node, wherein the message further indicates, for each path corresponding to the random access preambles, a set of allocated resources including at least a first set of resources, a second set of resources, or an uplink grant, and wherein the first set of resources corresponds to contention-based random access resources and the second set of resources corresponds to contention-free random access resources;
determining, for a path associated with a first random access preamble transmitted by the UE, whether a collision exists for the first random access preamble, wherein the determination is based at least in part on the path information and a round trip time associated with the first random access preamble; and
transmitting a random access message comprising a second random access preamble using the first set of resources, or the second set of resources, or the uplink grant, wherein the first set of resources, or the second set of resources, or the uplink grant is used for the random access message based at least in part on whether the collision exists for the path.

30. A method for wireless communications at a network node, comprising:
obtaining a plurality of random access preambles from a plurality of user equipment (UEs), wherein each random access preamble of the plurality of random access preambles is associated with a respective UE;
outputting a message indicating path information for the plurality of random access preambles, wherein the message further indicates, for each path corresponding to the plurality of random access preambles, a set of allocated resources including at least a first set of resources, a second set of resources, or an uplink grant, and wherein the first set of resources corresponds to contention-based random access resources and the second set of resources corresponds to contention-free random access resources; and
obtaining, from a UE of the plurality of UEs, a random access message comprising a first random access preamble using the first set of resources, or the second set of resources, or the uplink grant, wherein obtaining the random access message using the first set of resources, or the second set of resources, or the uplink grant is based at least in part on whether a collision exists for a path associated with a second random access preamble of the plurality of random access preambles.
